(19) United States
(12) Patent Application Publication
(10) Pub. No.: US 2012/0245823 A1
(43) Pub. Date: Sep. 27, 2012

(54) AIR-FUEL RATIO CONTROL APPARATUS FOR AN INTERNAL COMBUSTION ENGINE

(75) Inventor: Mamoru Yoshioka, Susono-shi (JP)

(73) Assignee: TOYOTA JIDOSHA KABUSHIKI KAISHA, Toyota-shi, Aichi (JP)

(21) Appl. No.: 13/503,584

(22) PCT Filed: Oct. 23, 2009
(86) PCT No.: PCT/JP2009/068636

§ 371 Date: May 24, 2012

(51) Int. Cl. F02D 41/26; F01N 3/10; F02D 41/32

(52) U.S. Cl. 701/104

(57) ABSTRACT

After rich control for controlling the air/fuel ratio of a mixture to be an air/fuel ratio richer than stoichiometric air/fuel ratio, lean control is carried out so that air/fuel ratio of the mixture formed in the combustion chamber is controlled to be an air/fuel ratio leaner by a predetermined degree than the stoichiometric air/fuel ratio, or the air/fuel ratio of the mixture is controlled to temporarily be the air/fuel ratio leaner by the predetermined degree than the stoichiometric air/fuel ratio. If lean control is carried out after rich control is finished, temporary lean control provides that a degree of how much the air/fuel ratio of the mixture is leaner than the stoichiometric air/fuel ratio when the air/fuel ratio of the mixture is controlled to be the air/fuel ratio leaner than the stoichiometric air/fuel ratio in lean control is lower than the predetermined degree according to the temperature of a catalyst.

### TECHNICAL FIELD

The present invention relates to a control apparatus for an internal combustion engine.

### BACKGROUND ART

Japanese Patent Application Laid-open No. S63-45444 discloses an air/fuel ratio control apparatus for an internal combustion engine of spark ignition type including a three-way catalyst in an exhaust passage. This air/fuel ratio control apparatus decreases a temperature of an exhaust gas discharged from combustion chambers by increasing the quantity of a fuel injected from fuel injection valves compared to an ordinary quantity, namely a quantity increase of the fuel injection quantity when a temperature of the three-way catalyst is higher than a target temperature, to thereby restraining the temperature rise of the catalyst in order to prevent the temperature from rising to be an excessively high temperature exceeding a predetermined temperature.

According to the above-mentioned publication, as long as a period in which an operation state of the internal combustion engine (the operation state of the internal combustion engine is referred to as an “engine operation state” hereinafter) in which the temperature of the exhaust gas discharged from the combustion chambers is relatively high due to a high rotation speed of the internal combustion engine (the rotation speed of the internal combustion engine is referred to as an “engine rotation speed” hereinafter) continues is relatively short, or a period in which an engine operation state where the temperature of the exhaust gas discharged from the combustion chambers is relatively high due to a high load of the internal combustion engine (the load of the internal combustion engine is referred to as an “engine load” hereinafter) continues is relatively short, the temperature of the exhaust gas discharged from the combustion chambers is lower than the target temperature (namely corresponding to a quantity increase determination temperature used for determining whether or not the quantity of the fuel injected from the fuel injection valve is increased compared to the ordinary quantity) without carrying the quantity increase of the fuel injection quantity. Moreover, as the engine rotation speed increases, or the engine load increases, the target temperature is set to be higher. As a result, even if the engine operation state is a state where the engine rotation speed is high, or even if the engine operation sate is a state where the engine load is high, the quantity increase of the fuel injection quantity is hard to be carried out immediately. This enables the apparatus to restrain/decrease the quantity of the fuel consumed for decreasing the temperature of the three way catalyst.

### SUMMARY OF THE INVENTION

As described above, the quantity increase of the fuel injection quantity for decreasing the temperature of the three way catalyst is publicly known, however, an exhaust gas containing unburned fuel flows into the three way catalyst while the quantity increase of the fuel injection quantity is being carried out. Therefore, the unburned fuel accumulates in the three way catalyst during the quantity increase of the fuel injection quantity.

In this case, when the engine is operated in the engine operation state where the air/fuel ratio of the mixture formed in the combustion chambers is leaner than the stoichiometric air/fuel ratio immediately after the end of the quantity increase of the fuel injection quantity, the exhaust gas containing a large quantity of oxygen flows into the three way catalyst. When this happens, since the substantial quantity of the unburned fuel has been accumulated in the three way catalyst as described above, the unburned fuel accumulated in the three way catalyst is burned with the oxygen flowing into the three way catalyst, and the temperature of the three way catalyst therefore increases. Accordingly, in some cases, the temperature of the three way catalyst exceeds a permissible temperature, and thus, a heat deterioration/degradation of the three way catalyst may occur.

This holds true for an internal combustion engine including a catalyst having an oxidization capability in an exhaust passage, and having the air/fuel ratio of a mixture formed in combustion chambers coincide with an air/fuel ratio richer than the stoichiometric air/fuel ratio.

In view of the above, an object of the present invention is to, in an internal combustion engine, which includes a catalyst having an oxidization capability in an exhaust passage, in which a rich control for controlling an air/fuel ratio of a mixture formed in a combustion chamber to be an air/fuel ratio richer than a stoichiometric air/fuel ratio is carried out, and in which a lean control for controlling the air/fuel ratio of the mixture formed in the combustion chamber to be an air/fuel ratio leaner than the stoichiometric air/fuel ratio or for temporarily controlling the air/fuel ratio of the mixture formed in the combustion chamber to be the air/fuel ratio leaner than the stoichiometric air/fuel ratio, prevent the heat deterioration/degradation of the catalyst even if the lean control is carried out after the end of the rich control.

In order to attain the object, according to a first invention, in an internal combustion engine, which includes a catalyst having an oxidization capability in an exhaust passage, in which a lean control for controlling an air/fuel ratio of a mixture formed in a combustion chamber to be an air/fuel ratio leaner than the stoichiometric air/fuel ratio by a predetermined degree or for temporarily controlling the air/fuel ratio of the mixture formed in the combustion chamber to be the air/fuel ratio leaner than the stoichiometric air/fuel ratio by the predetermined degree is carried out after a rich control for controlling the air/fuel ratio of the mixture formed in the combustion chamber to be an air/fuel ratio richer than the stoichiometric air/fuel ratio is carried out, a temporary lean control is carried out in which the air/fuel ratio of the mixture formed in the combustion chamber is controlled in such a manner that, when the lean control is carried out after the end of the rich control, a degree of how much the air/fuel ratio of the mixture formed in the combustion chamber is leaner than the stoichiometric air/fuel ratio while the air/fuel ratio of the mixture is set to be an air/fuel ratio leaner than the stoichiometric air/fuel ratio during the lean control is smaller than the predetermined degree according to a temperature of the catalyst.

According to this first invention, the degree of leanness when the air/fuel ratio of the mixture is controlled to be leaner than the stoichiometric air/fuel ratio after the completion of the rich control is decreased according to the temperature of the catalyst. A quantity of heat generation generated by the burning of unburned fuel accumulated in the catalyst owing to the oxygen in the exhaust gas flowing into the catalyst varies depending on the temperature of the catalyst. Moreover, this heat generation quantity also varies depending on the quantity of the oxygen in the exhaust gas flowing into the catalyst. According to this invention, the degree of leanness is decreased according to the temperature of the catalyst, thereby decreasing the quantity of the oxygen in the exhaust gas flowing into the catalyst. Consequently, the heat generation quantity generated by the burning of the unburned fuel accumulated in the catalyst during the rich control is decreased, and the heat deterioration/gradation of the catalyst is thereby restrained.

According to a second invention, in an air/fuel ratio control apparatus for an internal combustion engine including a catalyst having an oxidization capability in an exhaust passage, in which a lean control for controlling an air/fuel ratio of a mixture formed in a combustion chamber to be an air/fuel ratio leaner than the stoichiometric air/fuel ratio by a predetermined degree or for temporarily controlling the air/fuel ratio of the mixture formed in the combustion chamber to be the air/fuel ratio leaner than the stoichiometric air/fuel ratio by the predetermined degree is carried out after a rich control for controlling the air/fuel ratio of the mixture formed in the combustion chamber to be an air/fuel ratio richer than the stoichiometric air/fuel ratio is carried out, a temporary lean control is carried out in which the air/fuel ratio of the mixture formed in the combustion chamber is controlled, when the lean control is carried out after the end of the rich control and the temperature of the catalyst is higher than a predetermined temperature, in such a manner that a degree of how much the air/fuel ratio of the mixture formed in the combustion chamber is leaner than the stoichiometric air/fuel ratio while the air/fuel ratio of the mixture is set to be an air/fuel ratio leaner than the stoichiometric air/fuel ratio during the lean control is smaller than the predetermined degree.

According to this second invention, the degree of leanness when the air/fuel ratio of the mixture is controlled to be leaner than the stoichiometric air/fuel ratio after the completion of the rich control is decreased according to the temperature of the catalyst. A quantity of heat generation generated by the burning of unburned fuel accumulated in the catalyst owing to the oxygen in the exhaust gas flowing into the catalyst varies depending on the temperature of the catalyst. Moreover, this heat generation quantity also varies depending on the quantity of the oxygen in the exhaust gas flowing into the catalyst. According to this invention, the degree of leanness is decreased according to the temperature of the catalyst, thereby decreasing the quantity of the oxygen in the exhaust gas flowing into the catalyst. Consequently, the heat generation quantity generated by the burning of the unburned fuel accumulated in the catalyst during the rich control is decreased, and the heat deterioration/gradation of the catalyst is thereby restrained.

Moreover, according to a third invention, in the first or second invention, when the air/fuel ratio of the mixture formed in the combustion chamber is controlled to be the air/fuel ratio leaner than the stoichiometric air/fuel ratio in the temporary lean control, the air/fuel ratio of the mixture is controlled in such a manner that the degree of how much the air/fuel ratio of the mixture is leaner than the stoichiometric air/fuel ratio becomes smaller with respect to the predetermined degree as the temperature of the catalyst is higher.

According to this third invention, a degree of decrease in the degree of leanness when the air/fuel ratio of the mixture is controlled to be leaner than the stoichiometric air/fuel ratio after the end of the rich control is increased as the temperature of the catalyst increases. The quantity of heat generation generated by the burning of unburned fuel accumulated in the catalyst owing to the oxygen in the exhaust gas flowing into the catalyst increases as the temperature of the catalyst increases. According to the present invention, the degree of decrease in the degree of leanness is set according to the catalyst temperature, resulting in effective restraint of the heat deterioration of the catalyst.

Further, according to a fourth invention, in any one of the first to third inventions, when the air/fuel ratio of the mixture formed in the combustion chamber is controlled to be the air/fuel ratio leaner than the stoichiometric air/fuel ratio in the temporary lean control, the air/fuel ratio of the mixture is controlled in such a manner that the degree of how much the air/fuel ratio of the mixture is leaner than the stoichiometric air/fuel ratio becomes further smaller with respect to the predetermined degree if the quantity of the air taken into the combustion chamber is smaller than a predetermined quantity.

According to this fourth invention, the degree of leanness when the air/fuel ratio of the mixture is controlled to be leaner than the stoichiometric air/fuel ratio after the rich control is decreased according to the quantity of the air taken into the combustion chamber. The exhaust gas flowing into the catalyst takes heat from the catalyst, thereby decreasing the temperature of the catalyst. Therefore, if the heat quantity taken from the catalyst by the exhaust gas is small, the temperature of the catalyst is high. Accordingly, in order to restrain the heat deterioration of the catalyst, the degree of leanness should be smaller when the heat quantity taken from the catalyst by the exhaust gas is small. In addition, the heat quantity taken from the catalyst by the exhaust gas depends on the quantity of the exhaust gas flowing into the catalyst, namely the quantity of the air taken into the combustion chamber. According to the present invention, the degree of leanness is decreased according to the quantity of the air taken into the combustion chamber, and the heat deterioration of the catalyst is thus more surely restrained.

Further, according to the fifth invention, in the fourth invention, when the air/fuel ratio of the mixture formed in the combustion chamber is controlled to be the air/fuel ratio leaner than the stoichiometric air/fuel ratio in the temporary lean control, the air/fuel ratio of the mixture is controlled in such a manner that the degree of how much the air/fuel ratio of the mixture is leaner than the stoichiometric air/fuel ratio becomes further smaller with respect to the predetermined degree as the quantity of the air taken into the combustion chamber becomes smaller with respect to the predetermined quantity if the quantity of the air taken into the combustion chamber is smaller than the predetermined quantity.

According to this fifth invention, a degree of decrease in the degree of leanness when the air/fuel ratio of the mixture is controlled to be leaner than the stoichiometric air/fuel ratio after the end of the rich control is increased as the quantity of the air taken into the combustion chamber is smaller. The exhaust gas flowing into the catalyst takes heat from the catalyst, thereby decreasing the temperature of the catalyst. Therefore, as the heat quantity removed from the catalyst by the exhaust gas is smaller, the temperature of the catalyst is higher. Accordingly, in order to restrain the heat deterioration of the catalyst, the degree of leanness should be smaller when the heat quantity removed from the catalyst by the exhaust gas is small. In addition, the heat quantity taken from the catalyst by the exhaust gas decreases, as the quantity of the exhaust gas flowing into the catalyst, namely the quantity of air taken into the combustion chamber decreases. According to the present invention, the degree of decrease in degree of leanness is set according to the quantity of the air taken into the combustion chamber, and the heat deterioration of the catalyst is therefore more effectively restrained.

Moreover, according to a sixth invention, in any one of the first to fourth inventions, when the air/fuel ratio of the mixture formed in the combustion chamber is controlled to be the air/fuel ratio leaner than the stoichiometric air/fuel ratio in the temporary lean control, the air/fuel ratio of the mixture is controlled in such a manner that the degree of how much the air/fuel ratio of the mixture is leaner than the stoichiometric air/fuel ratio becomes further smaller with respect to the predetermined degree if an accumulated value of the quantity of the air taken into the combustion chamber after the end of the rich control is smaller than a predetermined value.

According to this sixth invention, the degree of leanness when the air/fuel ratio of the mixture is controlled to be leaner than the stoichiometric air/fuel ratio after the end of the rich control is decreased according to the accumulated value of the quantity of the air taken into the combustion chamber after the end of the rich control. The exhaust gas flowing into the catalyst takes heat from the catalyst, thereby decreasing the temperature of the catalyst. Therefore, as the heat quantity taken from the catalyst by the exhaust gas is smaller, the temperature of the catalyst is higher. Accordingly, the degree of leanness should be smaller in order to restrain the heat deterioration of the catalyst if the heat quantity taken from the catalyst by the exhaust gas decreases. In addition, the heat quantity taken from the catalyst by the exhaust gas depends on the accumulated value of the quantity of the exhaust gas flowing into the catalyst, namely the accumulated value of the quantity of air taken into the combustion chamber. According to the present invention, the degree of leanness is decreased according to the accumulated value of the quantity of the air taken into the combustion chamber after the end of the rich control, and the heat deterioration of the catalyst is thus more surely restrained.

Moreover, according to the seventh invention, in the sixth invention, when the air/fuel ratio of the mixture formed in the combustion chamber is controlled to be the air/fuel ratio leaner than the stoichiometric air/fuel ratio in the temporary lean control, the air/fuel ratio of the mixture is controlled in such a manner that, if the accumulated value of the quantity of the air taken into the combustion chamber after the end of the rich control is smaller than the predetermined value, the degree of how much the air/fuel ratio of the mixture is leaner than the stoichiometric air/fuel ratio becomes further smaller with respect to the predetermined degree as the accumulated value becomes smaller with respect to the predetermined value.

According to this seventh invention, a degree of decrease in the degree of leanness when the air/fuel ratio of the mixture is controlled to be leaner than the stoichiometric air/fuel ratio after the end of the rich control is increased as the accumulated value of the quantity of the air taken into the combustion chamber after the end of the rich control becomes smaller. The exhaust gas flowing into the catalyst takes heat from the catalyst, thereby decreasing the temperature of the catalyst. Therefore, as the heat quantity taken from the catalyst by the exhaust gas decreases, the temperature of the catalyst is higher. Accordingly, the degree of leanness should further become smaller in order to restrain the heat deterioration of the catalyst as the heat quantity taken from the catalyst by the exhaust gas decreases. In addition, the heat quantity taken from the catalyst by the exhaust gas decreases as the accumulated value of the quantity of the exhaust gas flowing into the catalyst, namely the accumulated value of the quantity of air taken into the combustion chamber is smaller. According to the present invention, the degree of decrease in degree of leanness is set according to the accumulated value of the quantity of the air taken into the combustion chamber, and the heat deterioration of the catalyst is thus more effectively restrained.

### BRIEF DESCRIPTION OF THE DRAWINGS

FIG. 1 is an overall view of an internal combustion engine to which an air/fuel ratio control apparatus according to the present invention is applied.

FIG. 2 is a chart showing a purification characteristic of a three way catalyst.

(A) of FIG. 3 is a chart illustrating a map used to determine a quantity decrease correction amount for an ordinary stoichiometric control and a rich control, and (B) of FIG. 3 is a chart illustrating map used to determine a quantity increase correction amount for the ordinary stoichiometric control and the rich control.

FIG. 4 is a chart showing a map used to determine a target air/fuel ratio for the rich control.

FIG. 5 is a chart showing a map used to determine a correction coefficient for correcting the quantity decrease correction amount according to a catalyst temperature in temporary stoichiometric control.

FIG. 6 is a chart describing the quantity decrease correction amount for temporary stoichiometric control.

FIGS. 7-9 are drawings showing an example of flowcharts for executing air/fuel ratio control according to a first embodiment.

FIG. 10 is a drawing showing an example of a flowchart for executing the rich air/fuel ratio control according to the first embodiment.

FIG. 11 is a drawing showing an example of a flowchart for executing the temporary stoichiometric air/fuel ratio control according to the first embodiment.

FIG. 12 is a drawing showing an example of a flowchart for the executing ordinary stoichiometric air/fuel ratio control according to the first embodiment.

(A) of FIG. 13 is a chart showing a map used to determine a correction coefficient for correcting the quantity decrease correction amount for the temporary stoichiometric control in accordance with a catalyst temperature according to a second embodiment, and (B) of FIG. 13 is a chart showing a map used to determine a correction coefficient for correcting a quantity decrease correction amount for the temporary stoichiometric control according to an air intake amount according to the second embodiment.

FIG. 14 is a drawing showing an example of a flowchart for executing the temporary stoichiometric air/fuel ratio control according to the second embodiment.

(A) of FIG. 15 is a chart showing a map used to determine a correction coefficient for correcting the quantity decrease correction amount for the temporary stoichiometric control in accordance with a catalyst temperature according to a third embodiment, and (B) of FIG. 15 is a chart showing a map used to determine a correction coefficient for correcting a quantity decrease correction amount for the temporary stoichiometric control in accordance with an accumulated intake air quantity according to the third embodiment.

FIG. 16 is a drawing showing an example of a flowchart for executing the temporary stoichiometric air/fuel ratio control according to the third embodiment.

FIG. 17 is a chart showing a map used to determine a correction coefficient for correcting a base air/fuel ratio for the temporary stoichiometric control according to a fourth embodiment.

FIGS. 18-20 are drawings showing an example of flowcharts for executing the air/fuel ratio control according to the fourth embodiment.

FIG. 21 is a drawing showing an example of a flowchart for executing the temporary stoichiometric air/fuel ratio control according to the fourth embodiment.

FIG. 22 is a chart showing a map used to determine a target rich period in the temporary stoichiometric control according to a fifth embodiment.

FIG. 23 is a drawing showing an example of a flowchart for executing the temporary stoichiometric air/fuel ratio control according to the fifth embodiment.

FIG. 24 is a drawing showing an example of a flowchart for executing the air/fuel ratio control according to a sixth embodiment.

### MODE FOR PERFORMING THE INVENTION

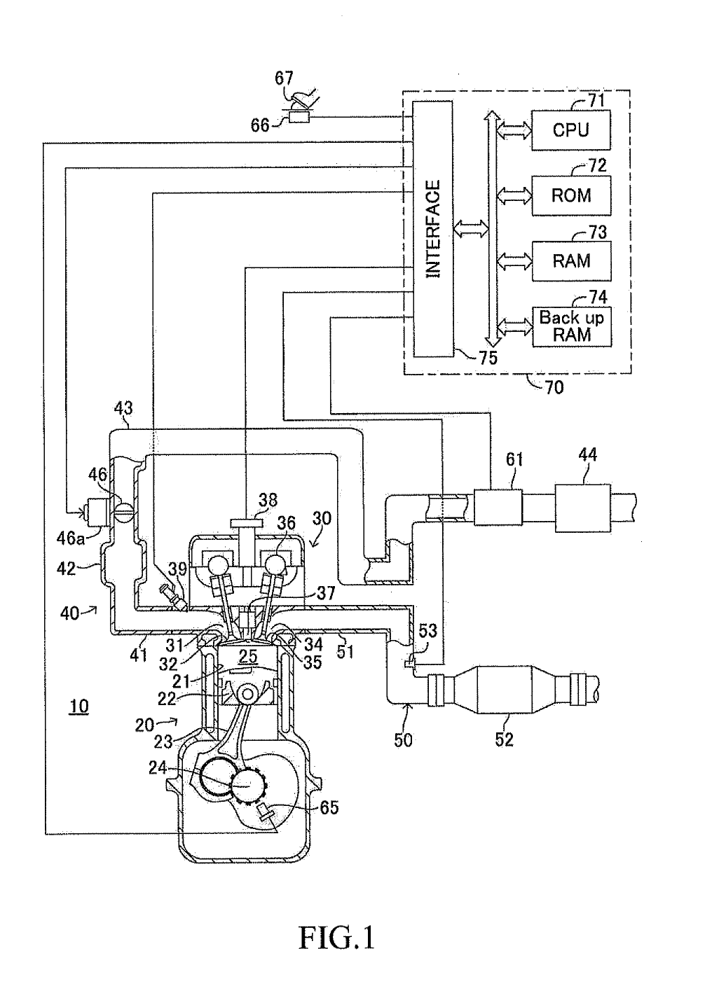

A description is now given of embodiments according to the present invention referring to drawings. Reference numeral 10 denotes an internal combustion engine in FIG. 1. The internal combustion engine 10 includes a cylinder block portion 20 having a cylinder block, a cylinder block lower case, and an oil pan; a cylinder head portion 30 fixed on the cylinder block portion 20; an intake air passage 40 for supplying a mixture of a fuel and the air to the cylinder block portion 20; and an exhaust gas passage 50 for discharging an exhaust gas from the cylinder block portion 20 to the outside.

The cylinder block portion 20 includes a cylinder 21, a piston 22, a connecting rod 23, and a crankshaft 24. The piston 22 reciprocates in the cylinder 21, and the reciprocating motion of the piston 22 is transmitted to the crankshaft 24 via the connecting rod 23, thereby rotating the crankshaft 24. Moreover, a combustion chamber 25 is formed by an inner wall surface of the cylinder 21, a top wall surface of the piston 22 and a bottom wall surface of the cylinder head portion 30.

The cylinder head portion 30 includes an intake port 31 communicating with the combustion chamber 25, an intake valve 32 for opening/closing the intake port 31, an exhaust port 34 communicating with the combustion chamber 25, and an exhaust valve 25 for opening/closing the exhaust port 34. Moreover, the cylinder head portion 30 includes an ignition plug 37 for igniting the fuel in the combustion chamber 25, an igniter 38 having an ignition coil applying a high voltage to the ignition plug 37, and a fuel injection valve 39 for injecting the fuel into the intake port 31.

The intake passage 40 includes intake branch pipes 41 connected to the intake ports 31, an surge tank 42 connected to the intake branch pipes 41, and an intake duct 43 connected to the surge tank 42. Further, an air filter 44, a throttle valve 46, and an actuator for driving throttle valve 46a for driving the throttle valve 46 in a sequence from an upstream end toward the downstream (toward the surge tank 42) are provided on the intake duct 43. Moreover, an airflow meter 61 for detecting a quantity of the air flowing through the intake duct 43 is provided on the intake duct 43.

The throttle valve 46 is rotatably attached to the intake duct 43, and is driven by the actuator 46a for driving throttle valve 46 thereby adjusting the opening thereof.

The exhaust passage 50 includes an exhaust pipe 51 having an exhaust branch pipes connected to the exhaust ports 34; and a three way catalyst provided on the exhaust pipe 51. An air/fuel ratio sensor 53 for detecting an air/fuel ratio of the exhaust gas is attached to the exhaust pipe 51 upstream of the three way catalyst 52.

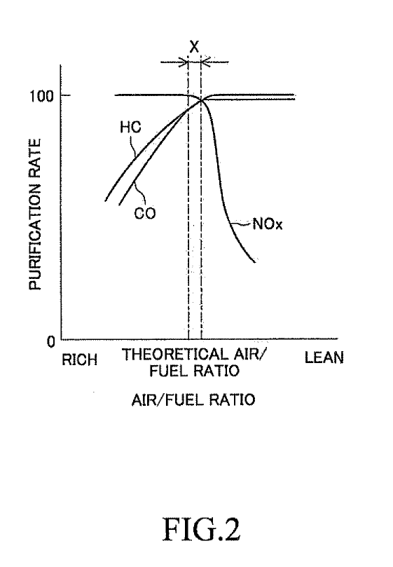

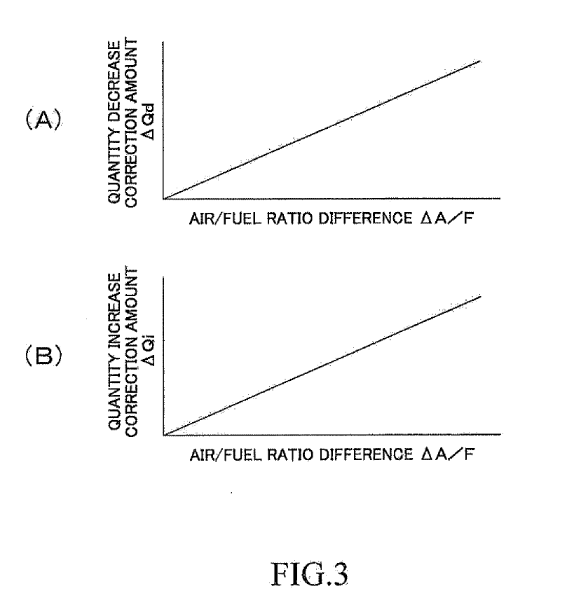

As shown in FIG. 2, the three way catalyst 52 can simultaneously purify nitrogen oxide (nitrogen oxide is denoted by “NOx” hereinafter), carbon monoxide (carbon monoxide is denoted by “CO” hereinafter), and hydrocarbon (hydrogen carbon is denoted by “HC” hereinafter) in the exhaust gas at high purification efficiency, when the temperature of the catalyst 52 is higher than a certain temperature (so-called activation temperature), and the air/fuel ratio of the exhaust gas flowing thereto is within an area X close to the stoichiometric air/fuel ratio. On the other hand, the three way catalyst 52 has an oxygen storage/release capability of storing oxygen in the exhaust gas when the air/fuel ratio of the exhaust gas flowing thereto is leaner than the stoichiometric air/fuel ratio, and of releasing the stored oxygen when the air/fuel ratio of the exhaust gas flowing thereto is richer than the stoichiometric air/fuel ratio. Therefore, as long as the oxygen storage/release capability is normally functioning, even if the air/fuel ratio of the exhaust gas flowing into the three way catalyst 52 is leaner or richer than the stoichiometric air/fuel ratio, an internal atmosphere of the three way catalyst 52 is maintained close to the stoichiometric air/fuel ratio, and thus, NOx, CO, and HC in the exhaust gas are simultaneously purified at high purification efficiency in the three way catalyst 52.

Further, the internal combustion engine 10 includes a crank position sensor 65 for detecting a phase angle of the crankshaft 24, an acceleration pedal opening sensor 66 for detecting a depressed quantity of an acceleration pedal 67, and an electric control unit (ECU) 70. The crank position sensor 65 generates a narrow pulse signal each time when the crank shaft 24 rotates by 10°, and generates a wide pulse each time when the crank shaft 24 rotates by 360°. The engine rotation speed (rotation speed of the internal combustion engine) can be calculated based on the pulse signals generated by the crank position sensor 65.

The electric control unit (ECU) 70 comprises a microcomputer, and includes a CPU (microprocessor) 71, a ROM (read only memory) 72, a RAM (random access memory) 73, a backup RAM 54, and an interface 75 having A/D converters, mutually connected by a bidirectional bus. The interface 75 is connected to the igniters 38, the fuel injection valves 39, the actuator for driving throttle valve 46a, the air/fuel ratio sensor 53, and the airflow meter 61.

The opening of the throttle valve 46 is basically controlled according to the depressed quantity of the acceleration pedal 67 detected by the accelerator opening sensor 66. In other words, the actuator for driving throttle valve 46a is operated in such a manner that the opening of the throttle valve 46 increases, namely the quantity of the air taken into the combustion chambers 25 passing through the throttle valve 46 (this quantity of the air is referred to as “intake air quantity” hereinafter) increases as the depressed quantity of the acceleration pedal 67 increases, and the actuator for driving throttle valve 46a is operated in such a manner that the opening of the throttle valve 46 decreases, namely the intake air quantity decreases as the depressed quantity of the acceleration pedal 67 decreases.

Meanwhile, as described above, the three way catalyst 52 simultaneously can purify NOx, CO, and HC at high purification efficiency when the air/fuel ratio of the exhaust gas flowing thereto is close to the stoichiometric air/fuel ratio. Thus, the air/fuel ratio of the mixture formed in the combustion chamber 25 (the air/fuel ratio of the mixture formed in the combustion chamber is simply referred to as “air/fuel ratio of mixture” hereinafter) is preferably controlled to be the stoichiometric air/fuel ratio in terms of maintaining high purification efficiency in the three way catalyst. In view of the above, an ordinary stoichiometric control for controlling the air/fuel ratio of the mixture to be the stoichiometric air/fuel ratio is carried out when the engine operation state (operation state of internal combustion engine) is in an ordinary state according to this embodiment (referred to as a “first embodiment” hereinafter).

That is, a quantity of the air taken into the combustion chambers 25, namely the intake air quantity is calculated in the ordinary stoichiometric control according to the first embodiment. The intake air quantity basically coincides with a quantity of the air flowing through the intake duct 43 detected by the airflow meter 61. However, the air flows through the air passage 40 having a certain length until the air which has passed through the airflow meter 61 is taken into the combustion chamber 25. Therefore, the quantity of the air detected by the airflow meter 61 may not coincide with the intake air quantity. In view of the above, considering this fact, a coefficient for having the quantity of the air detected by the airflow meter 61 coincide with the intake air quantity (this coefficient is referred to as an “intake air quantity calculation coefficient” hereinafter) is separately calculated, and the intake air quantity is calculated by multiplying the quantity of the air detected by the airflow meter 61 by the intake air quantity calculation coefficient, according to the first embodiment.

When the intake air quantity calculation coefficient is denoted by “KG”, the quantity of the air detected by the airflow meter 61 is denoted by “GA”, the target fuel injection quantity is denoted by “TQ”, and the air/fuel ratio detected by the air/fuel ratio sensor 53 is denoted by “A/F”, the intake air quantity calculation coefficient KG is a coefficient which is successively calculated by the following equation 1, and is stored in the ECU 70 as a learned value.

KG=(GA/TQ)/A/F (1)

Subsequently, a quantity of fuel to be injected from the fuel injection valve 39 (the quantity of the fuel to be injected from the fuel injection valve is referred to as a “fuel injection quantity” hereinafter) is calculated as a base fuel injection quantity in order to make the air/fuel ratio of the mixture coincide with the stoichiometric air/fuel ratio based on the intake air quantity calculated as described above.

Further, in the ordinary stoichiometric control according to the first embodiment, the air/fuel ratio detected by the air/fuel ratio sensor 53 (the air/fuel ratio detected by the air/fuel ratio sensor is referred to as a “detected air/fuel ratio” hereinafter) and the stoichiometric air/fuel ratio which is a target air/fuel ratio are compared with each other. When the detected air/fuel ratio is smaller than the stoichiometric air/fuel ratio, namely, when the detected air/fuel ratio is richer than the stoichiometric air/fuel ratio, the base fuel injection quantity is decreased by a predetermined quantity (the predetermined quantity is referred to as a “quantity decrease correction amount” hereinafter), and this decreased base fuel injection quantity is set to the target fuel injection quantity.

It is necessary for the decrease quantity correction amount to be set to (or at) a value which can make the air/fuel ratio of the mixture be leaner than the stoichiometric air/fuel ratio to. Thus, the decrease quantity correction amount increases as a difference between the detected air/fuel ratio and the stoichiometric air/fuel ratio serving as the target air/fuel ratio, (the difference between the detected air/fuel ratio and the target air/fuel ratio is referred to as an “air/fuel ratio difference” hereinafter) increases. In other words, the decrease quantity correction amount is a value depending on the air/fuel ratio difference. According to the first embodiment, considering this fact, the decrease quantity correction amount is obtained in advance by an experiment or the like for each of the air/fuel ratio differences, and this decrease quantity is stored in the ECU 70 as a decrease quantity correction amount ΔQd varying as a function of the air/fuel ratio difference ΔA/F in a form of a map, as shown in (A) of FIG. 3. When the detected air/fuel ratio is smaller than the stoichiometric air/fuel ratio, the decrease quantity correction amount ΔQd is read out from the map shown in (A) of FIG. 3 based on the air/fuel ratio difference ΔA/F during the ordinary stoichiometric control.

Thereafter, the fuel injection valve is controlled in such a manner that a fuel of the target fuel injection quantity set in this way is injected from the fuel injection valve 39. According to this configuration, the air/fuel ratio of the mixture richer than the stoichiometric air/fuel ratio is made leaner than the stoichiometric air/fuel ratio.

On the other hand, in the ordinary stoichiometric control according to the first embodiment, when the detected air/fuel ratio is larger than the stoichiometric air/fuel ratio which is the target air/fuel ratio, namely the detected air/fuel ratio is leaner than the stoichiometric air/fuel ratio, the base fuel injection quantity calculated as described above is increased by a predetermined quantity (this predetermined quantity is referred to as a “quantity increase correction amount” hereinafter), and the increased base fuel injection quantity is set to the target fuel injection quantity.

It is necessary for the quantity increase correction amount to be set to a value which can make the air/fuel ratio of the mixture be richer than the stoichiometric air/fuel ratio. Thus, the increase quantity correction amount increases as the air/fuel ratio difference (difference between the detected air/fuel ratio and the stoichiometric air/fuel ratio which is the target air/fuel ratio) increases. In other words, the increase quantity correction amount is a value depending on the air/fuel ratio difference. According to the first embodiment, considering this fact, the increase quantity correction amount is obtained in advance by an experiment or the like for each of the air/fuel ratio differences, and this increase quantity is stored in the ECU 70 as a increase quantity correction amount ΔQi varying as a function of the air/fuel ratio difference ΔA/F in a form of a map, as shown in (B) of FIG. 3. The increase quantity correction amount ΔQi is read out from the map shown in (B) of FIG. 3 based on the air/fuel ratio difference ΔA/F during the ordinary stoichiometric control.

Thereafter, the fuel injection valve is controlled in such a manner that a fuel of the target fuel injection quantity set in this way is injected from the fuel injection valve 39. According to this configuration, the air/fuel ratio of the mixture leaner than the stoichiometric air/fuel ratio is made richer than the stoichiometric air/fuel ratio.

As described above, according to the ordinary stoichiometric control of the first embodiment, when the air/fuel ratio of the mixture is richer than the stoichiometric air/fuel ratio, the air/fuel ratio of the mixture is made leaner than the stoichiometric air/fuel ratio; and when the air/fuel ratio of the mixture is leaner than the stoichiometric air/fuel ratio, the air/fuel ratio of the mixture is made richer than the stoichiometric air/fuel ratio. Therefore, the air/fuel ratio of the mixture fluctuates about the stoichiometric air/fuel ratio which is the target air/fuel ratio by the repetition of the control of the air/fuel ratio of the mixture. As a result, the air/fuel ratio of the mixture is controlled to be the stoichiometric air/fuel ratio as a whole.

Meanwhile, as long as the oxygen storage/release capability of the three way catalyst 52 normally functions, the three way catalyst 52 can purify NOx, CO, and HC simultaneously at high purification efficiency regardless of whether the air/fuel ratio of the exhaust gas flowing thereto is richer or leaner than the stoichiometric air/fuel ratio. In other words, when the quantity of oxygen stored in the three-way catalyst reaches a limit value which is a maximum value of oxygen that the three-way catalyst can store, the oxygen storage/release capability of the three-way catalyst can not function normally, and the three-way catalyst can thus no longer purify NOx, CO, and HC simultaneously at high purification efficiency. In this case, when the air/fuel ratio of the exhaust gas flowing into the three-way catalyst is lean, the three-way catalyst can not purify NOx, CO, and HC simultaneously at high purification efficiency. In view of the above, in the first embodiment, before the quantity of oxygen stored in the three-way catalyst 52 reaches the limit value which is the maximum value of oxygen that the three-way catalyst can store, the rich control is carried out for controlling the air/fuel ratio of the mixture to be richer than the stoichiometric air/fuel ratio in order to release the oxygen stored in the three-way catalyst from the three-way catalyst by supplying the exhaust gas richer than the stoichiometric air/fuel ratio to the three-way catalyst.

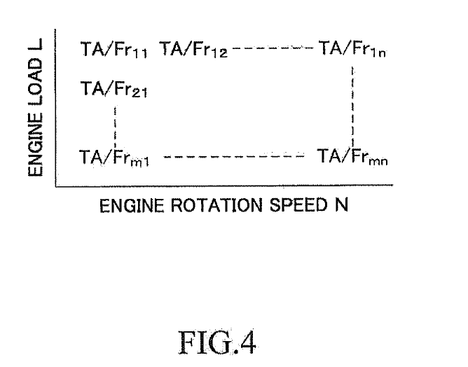

That is, according to the first embodiment, in the rich control carried out when the oxygen stored in the three-way catalyst 52 should be released from the three-way catalyst 52, an air/fuel ratio richer than the stoichiometric air/fuel ratio to be set as the target in the rich control is obtained for each of the engine operation states by means of an experiment or the like in advance, and this air/fuel ratio is stored in the ECU 70 as the target rich air/fuel ratio TA/Fr varying as a function of the engine rotation speed N and the engine load L in a form of a map shown in (A) of FIG. 4. The target rich air/fuel ratio TA/Fr is read out from the map shown in (A) of FIG. 4 based on the engine speed N and the engine load L during the rich control.

The intake air quantity is calculated as described above in the rich control according to the first embodiment. The quantity of the fuel, to be injected from the fuel injection valve 39, required to have the air/fuel ratio of the mixture coincide the target rich air/fuel ratio TA/Fr, is calculated as the base rich fuel injection quantity based on the calculated air quantity.

Thereafter, in the rich control according to the first embodiment, the detected air/fuel ratio (air/fuel ratio detected by the air/fuel ratio sensor 53) and the target rich air/fuel ratio read from the map shown in (A) of FIG. 4 are compared with each other, and when the detected air furl ratio is smaller than the target rich air/fuel ratio, namely, when the detected air/fuel ratio is richer than the target rich air/fuel ratio, the base rich fuel injection quantity calculated as described above is decreased by the predetermined quantity (decrease quantity correction amount), and this decreased base rich fuel injection quantity is set to the target fuel injection quantity.

The decrease quantity correction amount is set to (at) a value, which becomes larger as the air/fuel ratio difference (difference between the detected air/fuel ratio and the target rich air/fuel ratio) becomes larger, and which can make the air/fuel ratio of the mixture leaner than the target rich air/fuel ratio. In the rich control according to the first embodiment, when the detected air/fuel ratio is smaller than the target rich air/fuel ratio, the decrease quantity correction amount read from the map shown in (A) of FIG. 3 used in the ordinary stoichiometric control according to the first embodiment is used as the decrease quantity correction amount in the rich control. In other words, when the detected air/fuel ratio is smaller than the target rich air/fuel ratio, the decrease quantity correction amount ΔQd is read out from the map shown in (A) of FIG. 3 based on the air/fuel ratio difference ΔA/F during the rich control.

Thereafter, the fuel injection valve is controlled in such a manner that a fuel of the target fuel injection quantity set in this way is injected from the fuel injection valve 39. According to this configuration, the air/fuel ratio of the mixture richer than the stoichiometric air/fuel ratio is made leaner than the stoichiometric air/fuel ratio.

In contrast, in the rich control according to the first embodiment, when the detected air/fuel ratio is larger than the target rich air/fuel ratio, namely when the detected air/fuel ratio is leaner than the target rich air/fuel ratio, the base rich fuel injection quantity calculated as described above is increased by the predetermined quantity (increase quantity correction amount), and this increased base rich fuel injection quantity is set to the target fuel injection quantity.

The increase quantity correction amount is set to (at) a value, which becomes larger as the air/fuel ratio difference becomes larger, and which can make the air/fuel ratio of the mixture richer than the target rich air/fuel ratio. In the rich control according to the first embodiment, when the detected air/fuel ratio is larger than the target rich air/fuel ratio, the increase quantity correction amount read from the map shown in (B) of FIG. 3 used in the ordinary stoichiometric control according to the first embodiment is used as the increase quantity correction amount in the rich control. In other words, when the detected air/fuel ratio is larger than the target rich air/fuel ratio, the increase quantity correction amount ΔQi is read out from the map shown in (B) of FIG. 3 based on the air/fuel ratio difference ΔA/F during the rich control.

Thereafter, the fuel injection valve is controlled in such a manner that a fuel of the target fuel injection quantity set in this way is injected from the fuel injection valve 39. According to this configuration, the air/fuel ratio of the mixture leaner than the stoichiometric air/fuel ratio is made richer than the stoichiometric air/fuel ratio.

As described above, according to the rich control of the first embodiment, when the air/fuel ratio of the mixture is richer than the target rich air/fuel ratio, the air/fuel ratio of the mixture is made leaner than the target rich air/fuel ratio; and when the air/fuel ratio of the mixture is leaner than the target rich air/fuel ratio, the air/fuel ratio of the mixture is made richer than the target rich air/fuel ratio. Therefore, the air/fuel ratio of the mixture fluctuates about the target rich air/fuel ratio by the repetition of the control of the air/fuel ratio of the mixture. As a result, the air/fuel ratio of the mixture is controlled to be the target rich air/fuel ratio as a whole. Further, in the first embodiment, the rich control is carried out over a period in which the oxygen storage/release capability of the three way catalyst 52 is sufficiently recovered as long as the engine operation state permits.

Meanwhile, the unburned fuel is contained in the exhaust gas whose air/fuel ratio is richer than the stoichiometric air/fuel ratio. The exhaust gas whose air/fuel ratio is richer than the stoichiometric air/fuel ratio is supplied to the three way catalyst 52 while the rich control is carried out, and the unburned fuel is thus supplied to the three way catalyst. Consequently, when the rich control is finished/over, a relatively large amount of the unburned fuel is accumulated in the three way catalyst. Thereafter, when a certain period has elapsed after the rich control is finished, the unburned fuel accumulated in the three way catalyst is eliminated/treated by the purification action of the three way catalyst. However, in other words, until the certain period has elapsed after the end of the rich control, a relatively large quantity of the unburned fuel is accumulated in the three way catalyst. As described above, the air/fuel ratio of the mixture is made leaner or richer than the target stoichiometric air/fuel ratio, so that the air/fuel ratio of the entire mixture is controlled to be the target stoichiometric air/fuel ratio in the ordinary stoichiometric control. Accordingly, if the ordinary stoichiometric control is carried out immediately after the end of the rich control, the exhaust gas whose air/fuel ratio is leaner than the stoichiometric air/fuel ratio flows into the three way catalyst when the air/fuel ratio of the mixture is made leaner than the stoichiometric air/fuel ration during the ordinary stoichiometric control. Since a relatively large quantity of oxygen is contained in the exhaust gas whose air/fuel ratio is leaner than the stoichiometric air/fuel ratio, a relatively large quantity of oxygen is supplied to the three way catalyst if the ordinary stoichiometric control is carried out immediately after the end of the rich control. Therefore, if the temperature of the three way catalyst (the temperature of the three way catalyst is referred to as “catalyst temperature” hereinafter) is relatively high in such a case, the fuel accumulated in the three way catalyst is burned at once, and the catalyst temperature therefore becomes excessively high, thereby possibly causing the heat deterioration/degradation of the three way catalyst. In view of the above, in the first embodiment, a temporary stoichiometric control which controls the air/fuel ratio of the mixture to be the stoichiometric air/fuel ratio as described below is carried out until a predetermined period elapses after the end of the rich control.

That is, in the temporary stoichiometric control according to the first embodiment, the intake air quantity is calculated as in the ordinary stoichiometric control described above. Then, a quantity of the fuel to be injected from the fuel injection valve 39 in order to have the air/fuel ratio of the mixture coincide with the stoichiometric air/fuel ratio is calculated as the base fuel injection quantity based on this calculated intake air quantity, and the decrease quantity correction amount and the increase quantity correction amount are read from the maps in (A) of FIG. 3 and (B) of FIG. 3. Further, in the temporary stoichiometric control according to the first embodiment, as in the ordinary stoichiometric control, when the air/fuel ratio of the mixture is richer than the stoichiometric air/fuel ratio serving as the target air/fuel ratio, the base fuel injection quantity is corrected so that the air/fuel ratio of the mixture becomes leaner than the stoichiometric air/fuel ratio, and when the air/fuel ratio of the mixture is leaner than the stoichiometric air/fuel ratio, the base fuel injection quantity is corrected so that the air/fuel ratio of the mixture becomes richer than the stoichiometric air/fuel ratio. Here, in order to restrain the heat deterioration/degradation of the three way catalyst, it is necessary for a degree of leanness of the air/fuel ratio of the mixture with respect to the stoichiometric air/fuel ratio (the degree of leanness of the air/fuel ratio of the mixture with respect to the stoichiometric air/fuel ratio is referred to as a “degree of leanness” hereinafter) when the air/fuel ratio of the mixture is made leaner than the stoichiometric air/fuel ratio to be smaller than a degree of leanness at which a quantity of oxygen causing the heat deterioration/degradation of the three way catalyst is contained in the exhaust gas. Thus, the decrease quantity correction amount read from the map in (A) of FIG. 3 is corrected as described below in the temporary stoichiometric control according to the first embodiment.

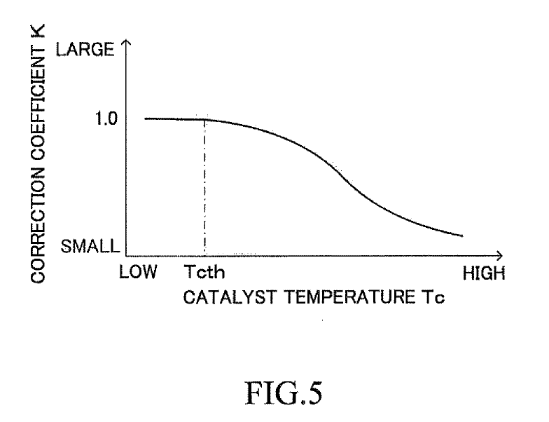

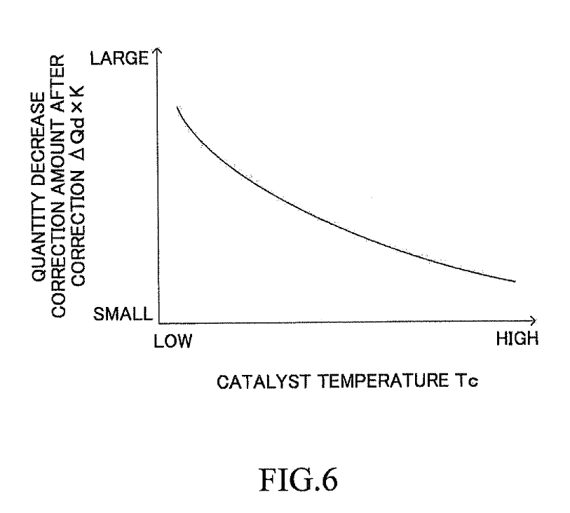

That is, the oxygen in the exhaust gas flowing into the three way catalyst burns the fuel accumulated in the three way catalyst. This burned quantity of the fuel increases as the quantity of the oxygen contained in the exhaust gas flowing into the three way catalyst increases, and further, the burned quantity of the fuel increases as the catalyst temperature (temperature of the three way catalyst 52) is higher. In other words, the quantity of the oxygen in the exhaust gas flowing into the three way catalyst, the quantity causing the heat deterioration/degradation of the three way catalyst (this quantity is referred to as a “catalyst heat deterioration oxygen quantity” hereinafter) depends on the catalyst temperature. According to the first embodiment considering this fact, a correction coefficient for correcting the decrease quantity correction amount read from the map in (A) of FIG. 3 is obtained for each catalyst temperature by means of an experiment or the like so that the quantity of the oxygen in the exhaust gas is (below) the catalyst heat deterioration oxygen quantity when the base fuel injection quantity is decreased by the decrease quantity correction amount so that the air/fuel ratio of the mixture is made leaner than the stoichiometric air/fuel ratio while the air/fuel ratio of the mixture is richer than the stoichiometric air/fuel ratio serving as the target air/fuel ratio in the temporary stoichiometric control, and this correction coefficient is stored in the ECU 70 as a correction coefficient K as a function of the catalyst temperature Tc in a form of map, as shown in FIG. 5. As appreciated from FIG. 5, the correction coefficient K takes a value 1.0 when the catalyst temperature Tc is equal to or lower than a certain temperature Tcth, and the correction coefficient K takes a value which is smaller than 1.0 and decreases as the catalyst temperature Tc becomes higher when the catalyst temperature Tc is higher than the certain temperature Tcth. During the temporary stoichiometric control, the correction coefficient K is read from the map in FIG. 5 based on the catalyst temperature Tc. Then, this correction coefficient K is multiplied by the decrease quantity correction amount read from the map in (A) of FIG. 3. As a result, when the catalyst temperature Tc is higher than the certain temperature Tcth, the decrease quantity correction amount read from the map in (A) of FIG. 3 is decreased by the correction coefficient as the catalyst temperature Tc becomes higher, as shown in FIG. 6. The calculated base fuel injection quantity is decreased by this decreased decrease quantity correction amount. As a result, the quantity of the oxygen contained in the exhaust gas decreases when the air/fuel ratio of the mixture is made leaner than the stoichiometric air/fuel ratio, and the heat deterioration of the three way catalyst is therefore restrained.

On the other hand, in the temporary stoichiometric control according to the first embodiment, when the air/fuel ratio of the mixture is leaner than the stoichiometric air/fuel ratio serving as the target air/fuel ratio, the base fuel injection quantity calculated as described above is increased by the increase quantity correction amount read from the map in (B) of FIG. 3, and this increased base fuel injection quantity is set to the target fuel injection quantity.

Thereafter, the fuel injection valve is controlled in such a manner that a fuel of the target fuel injection quantity set in this way is injected from the fuel injection valve 39.

By the way, when the engine load becomes extremely small, for example, when the depressed quantity of the acceleration pedal 67 becomes zero, a fuel cut control for setting the quantity of the fuel injected from the fuel injection valve 39 to zero is carried out according to the first embodiment. That is, in the first embodiment, an optimal intake air quantity as an intake air quantity (the quantity of the air taken into the combustion chamber 25) when the engine load becomes smaller than a predetermined load is obtained by means of an experiment or the like, and this intake air quantity is stored as the base intake air quantity in the ECU 70. The base intake air quantity is read from the ECU 70 during the fuel cut control, and this base intake air quantity is set to a target intake air quantity. Further, the opening of the throttle valve 46 is controlled so that the intake air quantity coincides with the target air quantity, without injecting the fuel from the fuel injection valve 39.

Meanwhile, in a case where the fuel cut control is carried out when the rich control is finished, the air/fuel ratio of the mixture becomes extremely lean with respect to the stoichiometric air/fuel ratio, and therefore, the exhaust gas whose air/fuel ratio is extremely lean with respect to the stoichiometric air/fuel ratio flows into the three way catalyst 52. Since a large quantity of oxygen is contained in the exhaust gas whose air/fuel ratio is extremely lean with respect to the stoichiometric air/fuel ratio, a large quantity of oxygen is supplied to the three way catalyst when the fuel cut control is carried out immediately after the end of the rich control. In such a case, if the catalyst temperature (the temperature of the three way catalyst 52) is relatively high, the fuel which has been accumulated during the rich control in the three way catalyst is burned at once, and thus the catalyst temperature becomes excessively high, thereby possibly causing the heat deterioration/degradation of the three way catalyst. In view of the above, in the first embodiment, until a predetermined period has elapsed after the end of the rich control, the temporary stoichiometric control is carried out even when the engine load is smaller than the predetermined load, which is the case in which the fuel cut control is usually carried out. As a result, the heat deterioration/degradation of the three way catalyst is restrained.

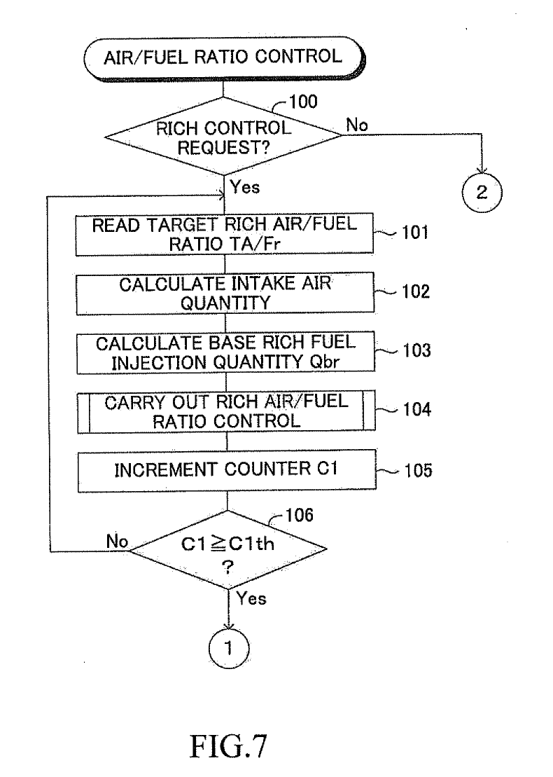

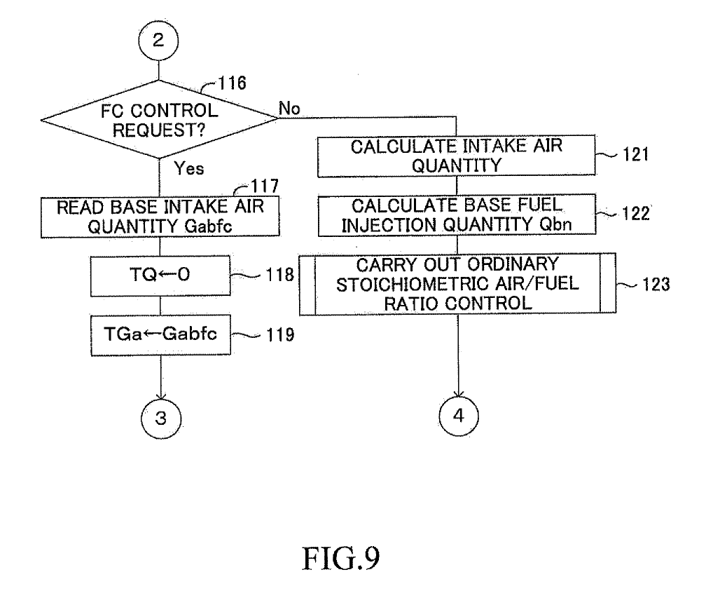

Next, there will be described the control of the air/fuel ratio according to the first embodiment with reference to FIGS. 7-9, and FIGS. 10-12. When the air/fuel ratio control shown in FIGS. 7-9 starts, it is firstly determined whether or not the execution of the rich control which controls the air/fuel ratio of the mixture formed in the combustion chamber 25 (the air/fuel ratio formed in the combustion chamber is simply referred to as “mixture” hereinafter) to be richer than the stoichiometric air/fuel ratio is required in step 100. When it is determined that the execution of the rich control is required, the routine proceeds to steps starting from step 101, the target fuel injection quantity for the rich control is set, and the target fuel injection quantity for the temporary stoichiometric control is set according to the necessity. In contrast, when it is determined that the execution of the rich control is not required, the routine proceeds to steps starting from step 116 in FIG. 9, and the target fuel injection quantity for the ordinary stoichiometric control for controlling the air/fuel ratio of the mixture to be the stoichiometric air/fuel ratio is set, or the target fuel injection quantity and the target intake air quantity for the fuel cut control are set. The fuel cut control causes the fuel injection quantity to be zero.

When it is determined that the execution of the rich control is not required in the step 100 shown in FIG. 7, and thus the routine proceeds to step 116 shown in FIG. 9, it is determined whether or not the execution of the fuel cut control (FC control) is required. When it is determined that the execution of the fuel cut control is required, the routine proceeds to steps starting from step 117, and the target fuel injection quantity and the target intake air quantity for the fuel cut control are set. In contrast, when it is determined that the execution of the fuel cut control is not required, the routine proceeds to steps starting from step 121, and the target fuel injection quantity for the ordinary stoichiometric control is set.

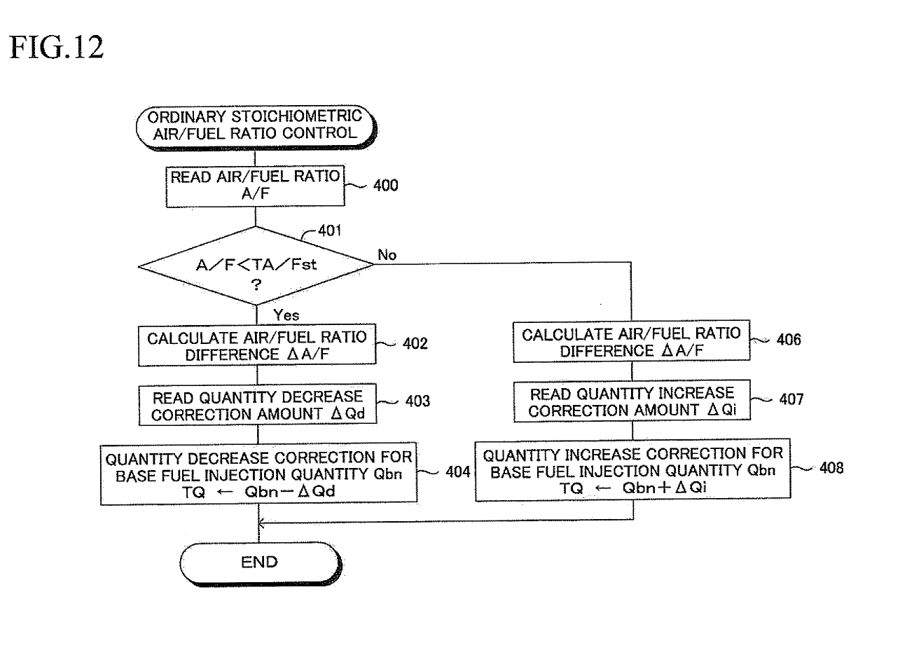

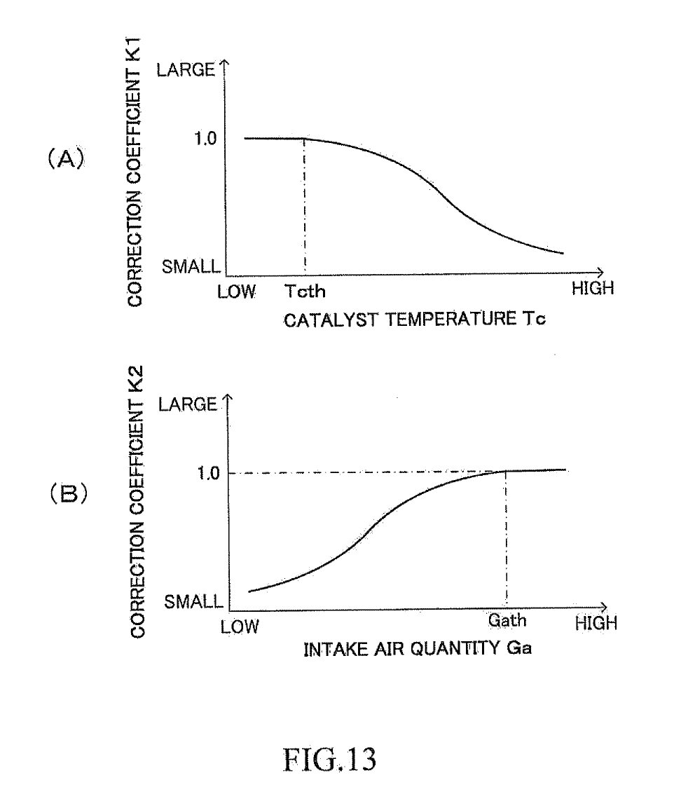

When it is determined that the execution of the fuel cut control is not required in step 116 shown in FIG. 9, and the routine therefore proceeds to step 121, the intake air quantity is calculated by multiplying the quantity of the air detected by the airflow meter 61 by the intake air quantity calculation coefficient. Then, in step 122, the quantity of the fuel to be injected from the fuel injection valve 39 and to have the air/fuel ratio of the mixture coincide with the stoichiometric air/fuel ratio is calculated as the base fuel injection quantity Qbn based on the intake air quantity calculated in step 121. Then, the ordinary stoichiometric air/fuel ratio control shown in FIG. 12 is carried out in step 123.

When the ordinary stoichiometric air/fuel ratio control shown in FIG. 12 starts, the air/fuel ratio A/F detected by the air/fuel ratio sensor 53 is firstly read out in step 400. Then, it is determined whether or not the air/fuel ratio A/F read in step 400 is smaller than the stoichiometric air/fuel ratio TA/Fst (A/F<TA/Fst), namely, whether or not the air/fuel ratio of the mixture is richer than the stoichiometric air/fuel ratio, in step 401. When it is determined that A/F<TA/Fst, namely, the air/fuel ratio of the mixture is richer than the stoichiometric air/fuel ratio, the routine proceeds to steps starting from step 402, and the air/fuel ratio control for making the air/fuel ratio of the mixture leaner than the stoichiometric air/fuel ratio is carried out. On the other hand, when it is determined that A/F≧TA/Fst, namely, the air/fuel ratio of the mixture is leaner than the stoichiometric air/fuel ratio, the routine proceeds to steps starting from step 406, and the air/fuel ratio control for making the air/fuel ratio of the mixture richer than the stoichiometric air/fuel ratio is carried out.

When it is determined that A/F≦TA/Fst in the step 401, namely it is determined that the air/fuel ratio of the mixture is richer than the stoichiometric air/fuel ratio, and when the routine therefore proceeds to the step 402, a difference between the air/fuel ratio read in the step 400 and the stoichiometric air/fuel ratio (air/fuel ratio difference) ΔA/F is calculated. Then, in step 403, the decrease quantity correction amount ΔQd according to the air/fuel ratio difference ΔA/F calculated in step 402, namely, the correction amount ΔQd for decreasing the base fuel injection quantity so that the air/fuel ratio of the mixture is made leaner than the stoichiometric air/fuel ratio when it is determined that the air/fuel ratio of the mixture is richer than the stoichiometric air/fuel ratio, is read from the map in (A) of FIG. 3. Next, in step 404, the base fuel injection quantity Qbn calculated in step 122 shown in FIG. 9 is decreased by the decrease quantity correction amount ΔQd read in step 403 (Qbn−ΔQd), this decreased base fuel injection quantity (Qbn−ΔQd) is input to the target fuel injection quantity TQ, and the routine ends. In this case, the operation of the fuel injection valve is controlled so that the fuel corresponding to the target fuel injection quantity TQ set in the step 404 is injected from the fuel injection valve 39, and, as a result, the air/fuel ratio of the mixture becomes leaner than the stoichiometric air/fuel ratio.

On the other hand, when it is determined that A/F≧TA/Fst in step 401, namely it is determined that the air/fuel ratio of the mixture is leaner than the stoichiometric air/fuel ratio, and when the routine therefore proceeds to step 406, a difference between the air/fuel ratio read in step 400 and the stoichiometric air/fuel ratio (air/fuel ratio difference) ΔA/F is calculated. Then, in step 407, the increase quantity correction amount ΔQi according to the air/fuel ratio difference ΔA/F calculated in step 406, namely the correction amount ΔQi for increasing the target fuel injection quantity so that the air/fuel ratio of the mixture is made richer than the stoichiometric air/fuel ratio, is read from the map in (B) of FIG. 3. Next, in step 408, the base fuel injection quantity Qbn calculated in step 122 shown in FIG. 9 is increased by the increase quantity correction amount ΔQi read in step 407 (Qbn+ΔQi), this increased base fuel injection quantity (Qbn+ΔQi) is input to the target fuel injection quantity TQ, and the routine ends. In this case, the operation of the fuel injection valve is controlled so that the fuel corresponding to the target fuel injection quantity TQ set in the step 408 is injected from the fuel injection valve 39, and, as a result, the air/fuel ratio of the mixture becomes richer than the stoichiometric air/fuel ratio.

On the other hand, when it is determined that the execution of the fuel cut control is required in step 116 shown in FIG. 9, and when the routine therefore proceeds to step 117, the base intake air quantity Gabfc for the fuel cut control is read. Then, zero is input to the target fuel injection quantity TO in step 118. Thereafter, the base intake air quantity Gabfc read in step 117 is input to the target intake air quantity TGa in step 119, and the routine ends. In this case, the fuel is not injected from the fuel injection valve 39, and the opening of the throttle valve 46 is controlled so that the air in the target intake air quantity TGa set in step 119 is taken into the combustion chamber 25.

Meanwhile, when it is determined that the execution of the rich control is required in step 100 shown in FIG. 7, and when the routine therefore proceeds to step 101, the target rich air/fuel ratio TA/Fr for the rich control according to the engine rotation speed N and the engine load L is read from the map in (A) of FIG. 4.

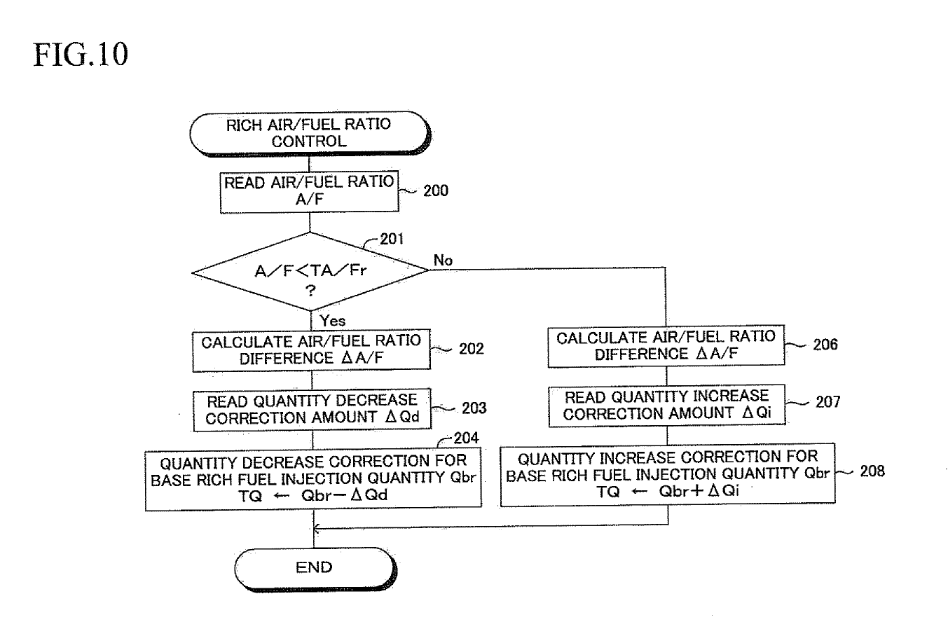

Thereafter, the intake air quantity is calculated by multiplying the intake air quantity calculation coefficient by the quantity of the air detected by the airflow meter 61 in step 102 following step 101. Then, in a step 103, the quantity of the fuel, to be injected from the fuel injection valve 39 and to have the air/fuel ratio of the mixture coincide with the target rich air/fuel ratio TA/Fr, is calculated as the base fuel injection quantity Qbr based on the intake air quantity calculated in step 102. Thereafter, in step 104, the rich air/fuel ratio control shown in FIG. 10 is carried out.

When the rich air/fuel ratio control shown in FIG. 10 starts, the air/fuel ratio A/F detected by the air/fuel ratio sensor 53 is firstly read in step 200. Then, in a step 201, it is determined whether or not the air/fuel ratio A/F read in step 200 is smaller than the target rich air/fuel ratio TA/Fr read in step 101 (A/F<TA/Fr), namely, it is determined whether or not the air/fuel ratio of the mixture is richer than the target rich air/fuel ratio TA/Fr. When it is determined that A/F<TA/Fr, namely, when it is determined that the air/fuel ratio of the mixture is richer than the target rich air/fuel ratio, the routine proceeds to steps starting from step 202, and the air/fuel ratio control for making the air/fuel ratio of the mixture leaner than the target rich air/fuel ratio is carried out. In contrast, when it is determined that A/F≧TA/Fr, namely, when it is determined that the air/fuel ratio of the mixture is leaner than the target rich air/fuel ratio, the routine proceeds to steps starting from step 206, and the air/fuel ratio control for making the air/fuel ratio of the mixture richer than the target rich air/fuel ratio is carried out.

When it is determined that A/F<TA/Fr in step 201, namely when it is determined that the air/fuel ratio of the mixture is richer than the target rich air/fuel ratio, and when the routine therefore proceeds to the step 202, a difference (air/fuel ratio difference) ΔA/F of the target rich air/fuel ratio read in step 101 with respect to the air/fuel ratio read in step 200 is calculated. Then, in step 203, the decrease quantity correction amount ΔQd according to the air/fuel ratio difference £A/F calculated in step 202, namely the correction amount ΔQd for decreasing the base fuel injection quantity so that the air/fuel ratio of the mixture is made leaner than the target rich air/fuel ratio when it is determined that the air/fuel ratio of the mixture is richer than the target rich air/fuel ratio, is read from the map in (A) of FIG. 3. Next, in step 204, the base rich fuel injection quantity Qbr calculated in step 103 shown in FIG. 7 is decreased by the decrease quantity correction amount ΔQd read in step 203 (Qbr−ΔQd), this decreased base rich fuel injection quantity (Qbr−ΔQd) is input to the target fuel injection quantity TQ, and the routine proceeds to step 105 shown in FIG. 7. In this case, the operation of the fuel injection valve is controlled so that the fuel corresponding to the target fuel injection quantity TQ set in the step 204 is injected from the fuel injection valve 39, and, as a result, the air/fuel ratio of the mixture becomes leaner than the target rich air/fuel ratio.

Meanwhile, when it is determined that A/F≧TA/Fr in step 201, namely it is determined that the air/fuel ratio of the mixture is leaner than the target rich air/fuel ratio, and when the routine therefore proceeds to step 206, a difference (air/fuel ratio difference) ΔA/F of the target rich air/fuel ratio read in step 101 shown in FIG. 7 with respect to the air/fuel ratio read in step 200 is calculated. Then, in step 207, the increase quantity correction amount ΔQi according to the air/fuel ratio difference ΔA/F calculated in step 206, namely the correction amount ΔQi for increasing the target fuel injection quantity so that the air/fuel ratio of the mixture is made richer than the target rich air/fuel ratio, is read from the map in (B) of FIG. 3. Next, in step 208, the base rich fuel injection quantity Qbr calculated in step 103 shown in FIG. 7 is increased by the increase quantity correction amount ΔQi read in step 207 (Qbn+ΔQi), this increased base rich fuel injection quantity (Qbr+ΔQi) is input to the target fuel injection quantity TQ, and the routine proceeds to step 105 shown in FIG. 7. In this case, the operation of the fuel injection valve is controlled so that the fuel corresponding to the target fuel injection quantity TQ set in the step 208 is injected from the fuel injection valve 39, and, as a result, the air/fuel ratio of the mixture becomes richer than the target rich air/fuel ratio.

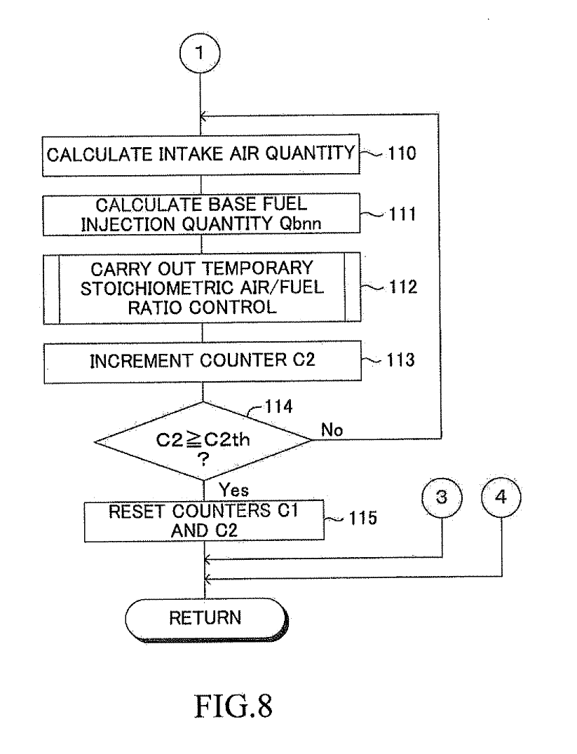

When the routine shown in FIG. 10 is executed, and the routine proceeds to step 105, a counter C1 representing a time period during which the rich control of steps 101-104 are being carried out is incremented. Then, in step 106, it is determined whether or not the counter C1 incremented in step 105 exceeds a predetermine period C1th (C1≧C1th), namely whether or not a time sufficient for recovering the oxygen storage/release capability of the three way catalyst 52 has elapsed since the start of the rich control. When it is determined that C1<C1th, namely when it is determined that the time sufficient for recovering the oxygen storage/release capability of the three way catalyst has not elapsed, the routine returns to the step 101, and the steps 101-104 are executed. With this configuration, until it is determined that C1≧C1th in step 106, namely until it is determined that the time sufficient for recovering the oxygen storage/release capability of the three way catalyst has elapsed, steps 101-105 are repeated. In contrast, when it is determined that C1≧C1th in step 106, the routine proceeds to steps starting from step 110 shown in FIG. 8, and the temporary stoichiometric control is carried out.

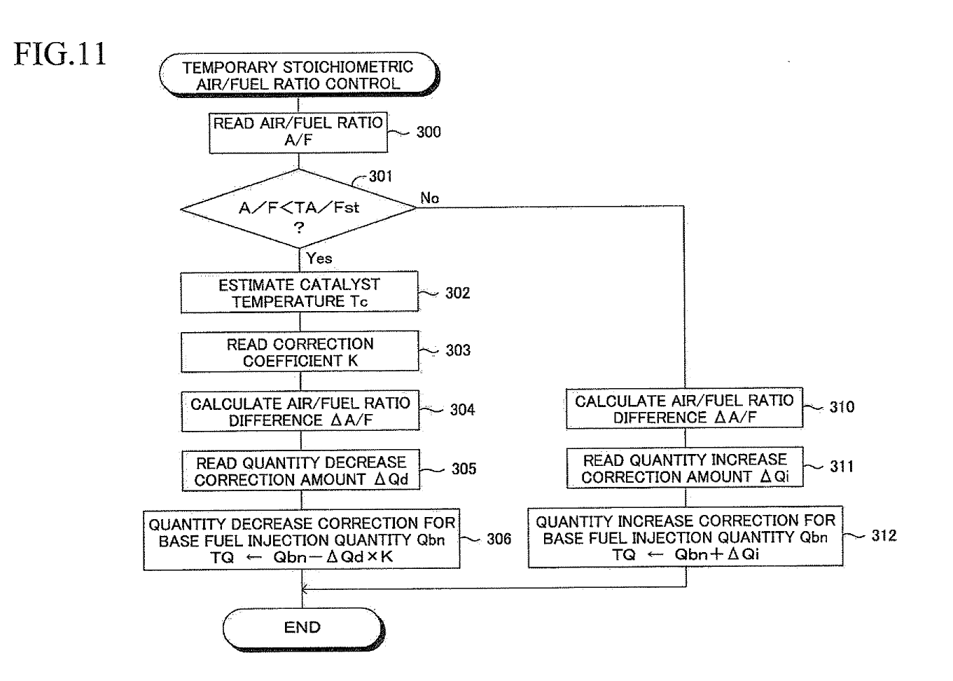

When it is determined that C1≧C1th, namely when it is determined that the time sufficient for recovering the oxygen storage/release capability of the three way catalyst has elapsed in step 106 shown in FIG. 7, and when the routine therefore proceeds to step 110 shown in FIG. 8, the intake air quantity is calculated by multiplying the quantity of the air detected by the airflow meter 61 by the intake air quantity calculation coefficient. Then, in step 111, the quantity of the fuel, to be injected from the fuel injection valve 39 and to have the air/fuel ratio of the mixture coincide with the stoichiometric air/fuel ratio, is calculated as the base fuel injection quantity Qbn based on the intake air quantity calculated in step 110. Thereafter, in step 112, the temporary stoichiometric air/fuel ratio control shown in FIG. 11 is carried out.

When the temporary stoichiometric air/fuel ratio control shown in FIG. 11 starts, the air/fuel ratio A/F detected by the air/fuel ratio sensor 53 is firstly read in step 300. Then, in step 301, it is determined whether or not the air/fuel ratio A/F read in step 300 is smaller than the stoichiometric air/fuel ratio TA/Fst serving as the target air/fuel ratio (A/F<TA/Fst), namely, whether or not the air/fuel ratio of the mixture is richer than the stoichiometric air/fuel ratio. When it is determined that A/F<TA/Fst, namely, when it is determined that the air/fuel ratio of the mixture is richer than the stoichiometric air/fuel ratio, the routine proceeds to steps starting from step 302, and the air/fuel ratio control for making the air/fuel ratio of the mixture leaner than the stoichiometric air/fuel ratio is carried out. In contrast, when it is determined that A/F≧TA/Fst, namely, when it is determined that the air/fuel ratio of the mixture is leaner than the stoichiometric air/fuel ratio, the routine proceeds to steps starting from step 310, and the air/fuel ratio control for making the air/fuel ratio of the mixture richer than the stoichiometric air/fuel ratio is carried out.

When it is determined that A/F<TA/Fst in the step 301, namely, when it is determined that the air/fuel ratio of the mixture is richer than the stoichiometric air/fuel ratio, and when the routine therefore proceeds to step 302, the catalyst temperature (temperature of the three way catalyst 52) Tc is estimated. Next, in step 303, the correction coefficient K according to the catalyst temperature Tc estimated in step 302 is read from the map shown in FIG. 5. Then, in step 304, a difference (air/fuel ratio difference) ΔA/F between the air/fuel ratio read in step 300 and the stoichiometric air/fuel ratio is calculated. Subsequently, the decrease quantity correction amount ΔQd according to the air/fuel ratio difference ΔA/F calculated in step 304, namely, the correction amount ΔQd for decreasing the base fuel injection quantity so that the air/fuel ratio of the mixture is made leaner than the stoichiometric air/fuel ratio when it is determined that the air/fuel ratio of the mixture is richer than the stoichiometric air/fuel ratio, is read from the map in (A) of FIG. 3. Next, in step 306, the base fuel injection quantity Qbn calculated in step 111 shown in FIG. 8 is decreased by a value (ΔQd×K) obtained by multiplying the decrease quantity correction amount ΔQd read in step 305 by the correction coefficient K read in step 303 (Qbn−ΔQd×K), this decreased base fuel injection quantity (Qbn−ΔQd×K) is input to the target fuel injection quantity TQ, and the routine ends. In this case, the operation of the fuel injection valve is controlled so that the fuel corresponding to the target fuel injection quantity TQ set in step 306 is injected from the fuel injection valve 39, and, as a result, the air/fuel ratio of the mixture becomes leaner than the stoichiometric air/fuel ratio.

In contrast, when it is determined that A/F≧TA/Fst in step 301, namely when it is determined that the air/fuel ratio of the mixture is leaner than the stoichiometric air/fuel ratio, and when the routine therefore proceeds to step 310, the difference (air/fuel ratio difference) ΔA/F between the air/fuel ratio read in step 300 and the stoichiometric air/fuel ratio is calculated. Then, in step 311, the increase quantity correction amount ΔQi according to the air/fuel ratio difference ΔA/F calculated in step 310, namely, the correction amount ΔQi for increasing the base fuel injection quantity so that the air/fuel ratio of the mixture is made richer than the stoichiometric air/fuel ratio when it is determined that the air/fuel ratio of the mixture is leaner than the stoichiometric air/fuel ratio is read from the map in (B) of FIG. 3. Thereafter, in step 312, the base fuel injection quantity Qbn calculated in step 111 shown in FIG. 8 is increased by the increase quantity correction amount ΔQi read in step 311 (Qbn+ΔQi), this increased base fuel injection quantity (Qbn+ΔQi) is input to the target fuel injection quantity TQ, and the routine ends. In this case, the operation of the fuel injection valve is controlled so that the fuel corresponding to the target fuel injection quantity TQ set in step 312 is injected from the fuel injection valve 39, and, as a result, the air/fuel ratio of the mixture becomes richer than the stoichiometric air/fuel ratio.

Meanwhile, the three way catalyst 52 is cooled by the exhaust gas passing through the three way catalyst. In this case, a cooling effect provided by the exhaust gas for the three way catalyst becomes weaker/smaller as the quantity of the exhaust gas passing through the three way catalyst per unit time becomes smaller. Thus, if the quantity of the exhaust gas passing through the three way catalyst per unit time is relatively small in the temporary stoichiometric control described above, the cooling effect provided by the exhaust gas for the three way catalyst is relatively small. In this case, when the degree of leanness of the mixture (degree of leanness with respect to the stoichiometric air/fuel ratio) is relatively large, the heat deterioration of the catalyst occurs due to the burning of the fuel accumulated in the three way catalyst. In contrast, the cooling effect provided by the exhaust gas for the three way catalyst becomes stronger/larger as the quantity of the exhaust gas passing through the three way catalyst per unit time increases. Thus, if the quantity of the exhaust gas passing through the three way catalyst per unit time is relatively large in the temporary stoichiometric control, the cooling effect provided by the exhaust gas for the three way catalyst is relatively large, and therefore, the heat deterioration of the catalyst generated due to the burning of the fuel accumulated in the three way catalyst will be restrained even when the degree of leanness of the mixture is relatively large. In view of the above, the following temporary stoichiometric control may be carried out in place of the temporary stoichiometric control according to the first embodiment.

That is, according to the present embodiment (referred to as a “second embodiment” hereinafter), correction coefficients for correcting the decrease quantity correction amount read from the map in (A) of FIG. 3 is obtained for each catalyst temperature and each intake air quantity by means of an experiment or the like so that the quantity of the oxygen in the exhaust gas is (below) the catalyst heat deterioration oxygen quantity (quantity of the oxygen causing the heat deterioration of the three way catalyst) when simultaneously considering the catalyst temperature and the intake air quantity (quantity of the air taken into the combustion chamber 25) corresponding to the quantity of the exhaust gas passing through the three way catalyst per unit time, when the base fuel injection quantity is decreased by the decrease quantity correction amount so that the air/fuel ratio of the mixture is made leaner than the stoichiometric air/fuel ratio while the air/fuel ratio of the mixture is richer than the stoichiometric air/fuel ratio serving as the target air/fuel ratio in the temporary stoichiometric control, and these correction coefficients are stored in the ECU 70 as correction coefficients K1 and K2 as functions of the catalyst temperature Tc and the intake air quantity Ga, respectively, in a form of maps, as shown in (A) of FIG. 13 and (B) of FIG. 13. As appreciated from (A) of FIG. 13, the correction coefficient K1 takes a value 1.0 when the catalyst temperature Tc is equal to or lower than the certain temperature Tcth, and the correction coefficient K1 takes a value which is smaller than 1.0 and decreases as the catalyst temperature Tc becomes higher when the catalyst temperature Tc is higher than the certain temperature Tcth. As appreciated from (B) of FIG. 13, the correction coefficient K2 takes a value 1.0 when the intake air quantity Ga is equal to or larger than the certain intake air quantity Gath, and the correction coefficient K2 takes a value which is smaller than 1.0 and decreases as the intake air quantity Ga becomes smaller when the intake air quantity Ga is smaller than the certain intake air quantity Gath. During the temporary stoichiometric control according to the second embodiment, the correction coefficient K1 is read from the map in (A) of FIG. 13 based on the catalyst temperature Tc, and the correction coefficient K2 is read from the map in (B) of FIG. 13 based on the intake air quantity Ga.

Thereafter, in the temporary stoichiometric control according to the second embodiment, similarly to the temporary stoichiometric control according to the first embodiment, the intake air quantity is calculated by multiplying the quantity of the air detected by the airflow meter 61 by the above-mentioned intake air quantity calculation coefficient, the quantity of the fuel, to be injected from the fuel injection valve 39 and to have the air/fuel ratio of the mixture coincide with the stoichiometric air/fuel ratio, is calculated as the base fuel injection quantity based on the calculated intake air quantity, and the decrease quantity correction amount and the increase quantity correction amount are read from the maps in (A) of FIG. 3 and (B) of FIG. 3.

In the temporary stoichiometric control according to the second embodiment, when the air/fuel ratio of the mixture is richer than the stoichiometric air/fuel ratio serving as the target air/fuel ratio, the base fuel injection quantity calculated as described above is decreased by the decreased quantity correction amount which is decreased by multiplying the decreased quantity correction amount read from the map in (A) of FIG. 3 by the correction coefficients K1 and K2 read from the maps in (A) of FIG. 13 and (B) of FIG. 13, and the decreased base fuel injection quantity is set to the target fuel injection quantity.

Thereafter, the fuel injection valve is controlled in such a manner that a fuel of the target fuel injection quantity set in this way is injected from the fuel injection valve 39.

On the other hand, in the temporary stoichiometric control according to the second embodiment, when the air/fuel ratio of the mixture is leaner than the stoichiometric air/fuel ratio serving as the target air/fuel ratio, the base fuel injection quantity calculated as described above is increased by the increase quantity correction amount read from the map in (B) of FIG. 3, and this increased base fuel injection quantity is set to the target fuel injection quantity.

Thereafter, the fuel injection valve is controlled in such a manner that a fuel of the target fuel injection quantity set in this way is injected from the fuel injection valve 39.

In the temporary stoichiometric control according to the second embodiment, the quantity of the exhaust gas passing through the three way catalyst per unit time is considered in addition to the temperature of the three way catalyst, which is a cause relating to the heat deterioration of the three way catalyst. Therefore, the fuel which has been accumulated in the three way catalyst is purified/treated earlier by the combustion thereof while the heat deterioration of the three way catalyst is restrained.

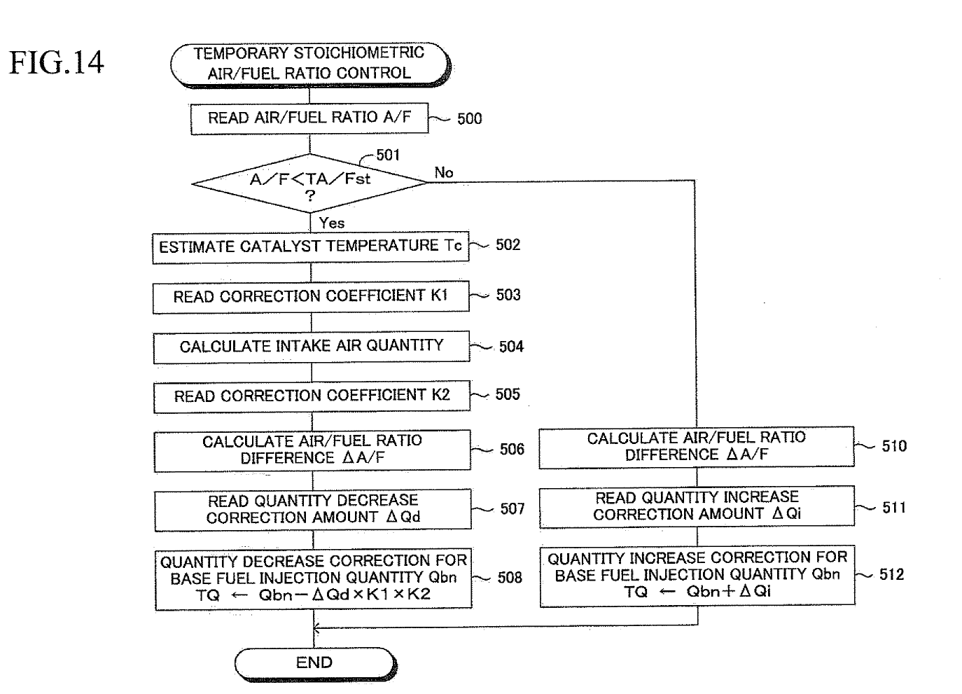

Next, there will be described an example of flowcharts carrying out the air/fuel ratio control according to the second embodiment. In the control of the air/fuel ratio according to the second embodiment, the flowcharts shown in FIGS. 7-9, 10, 12, and 14 are used. The flowcharts shown in FIGS. 7-9, 10, and 12 have already been described, and a description thereof is therefore omitted. Thus, a description will now be given of the flowchart shown in FIG. 14.

According to the second embodiment, when it is determined that the counter C1 representing the elapsed period after the start of the rich control exceeds the predetermined period C1th (C1≧C1th) in step 106 shown in FIG. 7, the intake air quantity and the base fuel injection quantity Qbn are calculated in steps 110 and 111 shown in FIG. 8, and when the routine proceeds to the step 112, the temporary stoichiometric air/fuel ratio control shown in FIG. 14 is carried out.

When the temporary stoichiometric air/fuel ratio control shown in FIG. 14 starts, the air/fuel ratio A/F detected by the air/fuel ratio sensor 53 is firstly read in step 500. Then, in step 501, it is determined whether or not the air/fuel ratio A/F read in step 500 is smaller than the stoichiometric air/fuel ratio TA/Fst (A/F<TA/Fst), namely, whether or not the air/fuel ratio of the mixture is richer than the stoichiometric air/fuel ratio. When it is determined that A/F<TA/Fst, namely, when it is determined that the air/fuel ratio of the mixture is richer than the stoichiometric air/fuel ratio, the routine proceeds to steps starting from step 502, and the air/fuel ratio control for making the air/fuel ratio of the mixture leaner than the stoichiometric air/fuel ratio is carried out. On the other hand, when it is determined that A/F≧TA/Fst, namely, when it is determined that the air/fuel ratio of the mixture is leaner than the stoichiometric air/fuel ratio, the routine proceeds to steps starting from step 510, and the air/fuel ratio control for making the air/fuel ratio of the mixture richer than the stoichiometric air/fuel ratio is carried out.

When it is determined that A/F<TA/Fst in step 501, namely, when it is determined that the air/fuel ratio of the mixture is richer than the stoichiometric air/fuel ratio, and when the routine therefore proceeds to step 502, the temperature of the three way catalyst (catalyst temperature) Tc is estimated. Thereafter, in step 503, the correction coefficient K1 according to the catalyst temperature Tc estimated in step 502 is read from the map in (A) of FIG. 13. Then, in step 504, the intake air quantity is calculated by multiplying the quantity of the air detected by the airflow meter 61 by the intake air quantity calculation coefficient. Subsequently, in step 505, the correction coefficient K2 according to the intake air quantity obtained in step 504 is read from the map in (B) of FIG. 13. Then, in step 506, a difference (air/fuel ratio difference) ΔA/F between the air/fuel ratio read in the step 500 and the stoichiometric air/fuel ratio is calculated. Next, in step 507, the decrease quantity correction amount ΔQd according to the air/fuel ratio difference ΔA/F calculated in step 506, namely, the correction amount ΔQd for decreasing the base fuel injection quantity so that the air/fuel ratio of the mixture is made leaner than the stoichiometric air/fuel ratio when it is determined that the air/fuel ratio of the mixture is richer than the stoichiometric air/fuel ratio is read from the map in (A) of FIG. 3. Then, in step 508, the base fuel injection quantity Qbn calculated in step 111 shown in FIG. 8 is decreased by a value (ΔQd×K1×K2) obtained by multiplying the decrease quantity correction amount ΔQd read in step 507 multiplied by the correction coefficient K1 read in step 503 and the correction coefficient K2 read in step 505 (Qbn−ΔQd×K1×K2), this decreased base fuel injection quantity (Qbn−ΔQd×K1×K2) is input to the target fuel injection quantity TQ, and the routine ends. In this case, the operation of the fuel injection valve is controlled so that the fuel corresponding to the target fuel injection quantity TQ set in step 508 is injected, and, as a result, the air/fuel ratio of the mixture becomes leaner than the stoichiometric air/fuel ratio.

In contrast, when it is determined that A/F≧TA/Fst in step 501, namely when it is determined that the air/fuel ratio of the mixture is leaner than the stoichiometric air/fuel ratio, and when the routine therefore proceeds to step 510, the difference between the air/fuel ratio read in the step 500 and the stoichiometric air/fuel ratio (air/fuel ratio difference) ΔA/F is calculated. Then, in step 511, the increase quantity correction amount ΔQi according to the air/fuel ratio difference ΔA/F calculated in step 510, namely, the correction amount ΔQi for increasing the base fuel injection quantity so that the air/fuel ratio of the mixture is made richer than the stoichiometric air/fuel ratio when it is determined that the air/fuel ratio of the mixture is leaner than the stoichiometric air/fuel ratio is read from the map in (B) of FIG. 3. Then, in step 512, the base fuel injection quantity Qbn calculated in step 111 shown in FIG. 8 is increased by the increase quantity correction amount ΔQi read in step 511 (Qbn+ΔQi), this increased base fuel injection quantity (Qbn+ΔQi) is input to the target fuel injection quantity TQ, and the routine ends. In this case, the operation of the fuel injection valve is controlled so that the fuel corresponding to the target fuel injection quantity TQ set in step 512 is injected from the fuel injection valve 39, and, as a result, the air/fuel ratio of the mixture becomes richer than the stoichiometric air/fuel ratio.

By the way, as described above, the three way catalyst 52 is cooled by the exhaust gas passing through the three way catalyst. The cooling effect provided by the exhaust gas for the three way catalyst becomes weaker/smaller as a total quantity of the exhaust gas passing through the three way catalyst is smaller. Thus, in the above-mentioned temporary stoichiometric control, if the total quantity of the exhaust gas passing through the three way catalyst is relatively small after the end of the rich control, the cooling effect provided by the exhaust gas for the three way catalyst flowed in to the three way catalyst after the end of the rich control is relatively small, and therefore, the heat deterioration of the catalyst occurs due to the burning of the fuel which has been accumulated in the three way catalyst if the degree of leanness of the mixture, namely the degree of leanness with respect to the stoichiometric air/fuel ratio, is relatively large. Conversely, the cooling effect provided by the exhaust gas for the three way catalyst becomes larger/stronger as the total quantity of the exhaust gas passing through the three way catalyst becomes larger. Accordingly, in the temporary stoichiometric control, if the total quantity of the exhaust gas passing through the three way catalyst is relatively large after the end of the rich control, the cooling effect provided by the exhaust gas for the three way catalyst is relatively large after the end of the rich control. Thus, in this case, the heat deterioration of the catalyst caused by the burning of the fuel accumulated in the three way catalyst will be restrained, even if the degree of leanness of the mixture, namely the degree of leanness with respect to the stoichiometric air/fuel ratio, is relatively large. In view of the above, the following temporary stoichiometric control may be carried out in place of the temporary stoichiometric control according to the first embodiment.

That is, according to the present embodiment (referred to as a “third embodiment” hereinafter), correction coefficients for correcting the decrease quantity correction amount read from the map in (A) of FIG. 3 is obtained for each catalyst temperature and each total quantity of the exhaust gas which has passed through the three way catalyst after the end of the rich control by means of an experiment or the like so that the quantity of the oxygen in the exhaust gas is (below) the catalyst heat deterioration oxygen quantity (quantity of the oxygen causing the heat deterioration of the three way catalyst) when simultaneously considering the catalyst temperature and the total quantity of the exhaust gas which has passed through the three way catalyst after the end of the rich control, namely, the total quantity of the intake air quantity after the end of the rich control, when the base fuel injection quantity is decreased by the decrease quantity correction amount so that the air/fuel ratio of the mixture is made leaner than the stoichiometric air/fuel ratio while the air/fuel ratio of the mixture is richer than the stoichiometric air/fuel ratio serving as the target air/fuel ratio in the temporary stoichiometric control, and these correction coefficients are stored in the ECU 70 as correction coefficients K1 and K2 as functions of the catalyst temperature Tc and the accumulated intake air quantity ΣGa after the end of the rich control, respectively, in a form of maps, as shown in (A) of FIG. 15 and (B) of FIG. 15, As appreciated from (A) of FIG. 15, the correction coefficient K1 takes a value 1.0 when the catalyst temperature Tc is equal to or lower than the certain temperature Tcth, and the correction coefficient K1 takes a value which is smaller than 1.0 and becomes smaller as the catalyst temperature Tc becomes higher when the catalyst temperature Tc is higher than the certain temperature Tcth. As appreciated from (B) of FIG. 15, the correction coefficient K3 takes a value 1.0 when the accumulated intake air quantity ΣGa is equal to or larger than a certain accumulated intake air quantity ΣGath, and the correction coefficient K3 takes a value which is smaller than 1.0 and becomes smaller as the accumulated intake air quantity ΣGa becomes smaller when the accumulated intake air quantity ΣGa is smaller than the certain accumulated intake air quantity ΣGath. During the temporary stoichiometric control according to the second embodiment, the correction coefficient K1 is read from the map in (A) of FIG. 13 based on the catalyst temperature Tc, and the correction coefficient K2 is read from the map in (B) of FIG. 13 based on the intake air quantity Ga. Thereafter, in the temporary stoichiometric control according to the third embodiment, similarly to the temporary stoichiometric control according to the first embodiment, the intake air quantity is calculated by multiplying the quantity of the air detected by the airflow meter 61 by the above-mentioned intake air quantity calculation coefficient, the quantity of the fuel, to be injected from the fuel injection valve 39 and to have the air/fuel ratio of the mixture coincide with the stoichiometric air/fuel ratio, is calculated as the base fuel injection quantity based on the calculated intake air quantity, and the decrease quantity correction amount and the increase quantity correction amount are read from the maps in (A) of FIG. 3 and (B) of FIG. 3.

In the temporary stoichiometric control according to the third embodiment, when the air/fuel ratio of the mixture is richer than the stoichiometric air/fuel ratio serving as the target air/fuel ratio, the base fuel injection quantity calculated as described above is decreased by the decreased quantity correction amount which is decreased by multiplying the decreased quantity correction amount read from the map in (A) of FIG. 3 by the correction coefficients K1 and K3 read from the maps in (A) of FIG. 15 and (B) of FIG. 15, and the decreased base fuel injection quantity is set to the target fuel injection quantity.

Thereafter, the fuel injection valve is controlled in such a manner that a fuel of the target fuel injection quantity set in this way is injected from the fuel injection valve 39.

On the other hand, in the temporary stoichiometric control according to the third embodiment, when the air/fuel ratio of the mixture is leaner than the stoichiometric air/fuel ratio serving as the target air/fuel ratio, the base fuel injection quantity calculated as described above is increased by the increase quantity correction amount read from the map in (B) of FIG. 3, and this increased base fuel injection quantity is set to the target fuel injection quantity.

Thereafter, the fuel injection valve is controlled in such a manner that a fuel of the target fuel injection quantity set in this way is injected from the fuel injection valve 39.

In the temporary stoichiometric control according to the third embodiment, the total quantity of the exhaust gas which has passed through the three way catalyst after the end of the rich control is considered in addition to the temperature of the three way catalyst, which is a cause relating to the heat deterioration of the three way catalyst. Therefore, the fuel which has been accumulated in the three way catalyst is purified/treated earlier by the combustion thereof while the heat deterioration of the three way catalyst is restrained. Further, while the momentary heat quantity taken/deprived by the exhaust gas from the three way catalyst is considered in the temporary stoichiometric control according to the second embodiment which considers the quantity of the exhaust gas passing through the three way catalyst, the heat quantity deprived/taken by the exhaust gas from the three way catalyst after the end of the rich control is considered in the temporary stoichiometric control according to the third embodiment. In other words, the momentary temperature of the three way catalyst is considered in the temporary stoichiometric control according to the third embodiment. Therefore, the heat deterioration of the three way catalyst is more surely restrained.

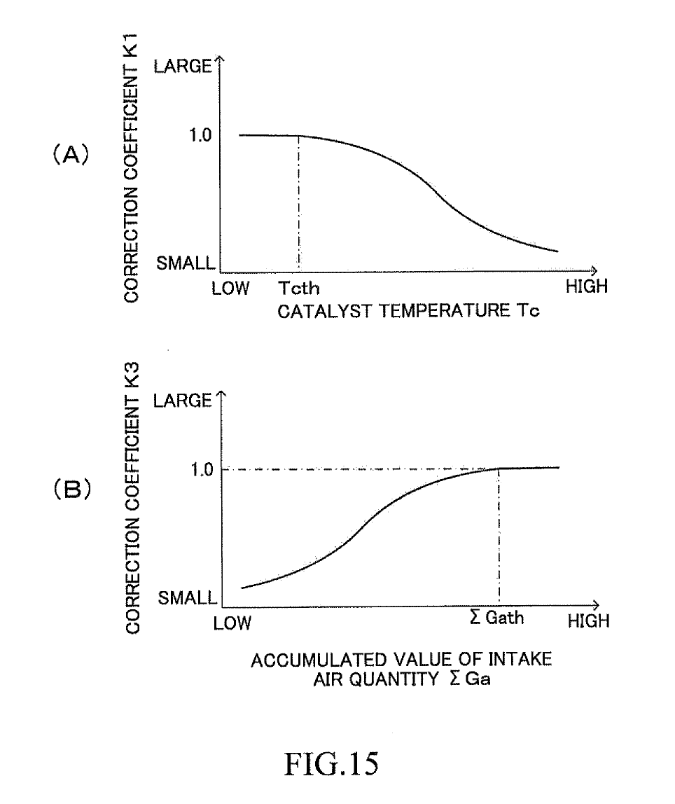

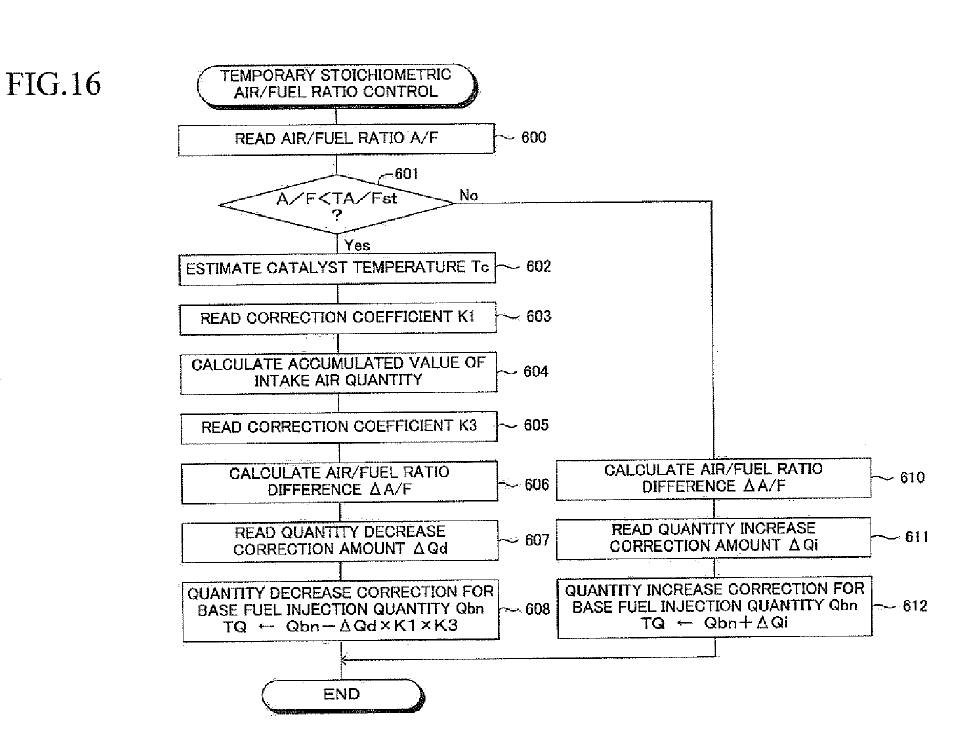

Next, there will be described an example of flowcharts carrying out the air/fuel ratio control according to the third embodiment. In the control of the air/fuel ratio according to the third embodiment, the flowcharts shown in FIGS. 7-9, 10, 12, and 16 are used. The flowcharts shown in FIGS. 7-9, 10, and 12 have already been described, and a description thereof is therefore omitted. Thus, a description will now be given of the flowchart shown in FIG. 16.

According to the third embodiment, when it is determined that the counter C1 representing the elapsed period after the start of the rich control exceeds the predetermined period C1th (C1≧C1th) in step 106 shown in FIG. 7, the intake air quantity and the base fuel injection quantity Qbn are calculated in steps 110 and 111 shown in FIG. 8, and when the routine proceeds to the step 112, the temporary stoichiometric air/fuel ratio control shown in FIG. 16 is carried out.

When the temporary stoichiometric air/fuel ratio control shown in FIG. 16 starts, the air/fuel ratio A/F detected by the air/fuel ratio sensor 53 is firstly read in step 600. Then, in step 601, it is determined whether or not the air/fuel ratio A/F read in step 600 is smaller than the stoichiometric air/fuel ratio TA/Fst (A/F<TA/Fst), namely, it is determined whether or not the air/fuel ratio of the mixture is richer than the stoichiometric air/fuel ratio. When it is determined that A/F<TA/Fst, namely, when it is determined that the air/fuel ratio of the mixture is richer than the stoichiometric air/fuel ratio, the routine proceeds to steps starting from step 602, and the air/fuel ratio control for making the air/fuel ratio of the mixture leaner than the stoichiometric air/fuel ratio is carried out. On the other hand, when it is determined that A/F≧TA/Fst, namely, when it is determined that the air/fuel ratio of the mixture is leaner than the stoichiometric air/fuel ratio, the routine proceeds to steps starting from step 610, and the air/fuel ratio control for making the air/fuel ratio of the mixture richer than the stoichiometric air/fuel ratio is carried out.

When it is determined that A/F<TA/Fst in step 601, namely, when it is determined that the air/fuel ratio of the mixture is richer than the stoichiometric air/fuel ratio, and when the routine therefore proceeds to step 602, the temperature of the three way catalyst (catalyst temperature) Tc is estimated. Thereafter, in step 603, the correction coefficient K1 according to the catalyst temperature Tc estimated in step 602 is read from the map in (A) of FIG. 15. Then, in step 604, the accumulated value of the intake air quantity, which is calculated by multiplying the quantity of the air detected by the airflow meter 61 by the intake air quantity calculation coefficient, after the end of the rich control ΣGa is calculated. Subsequently, in step 605, the correction coefficient K3 according to the accumulated value of the intake air quantity ΣGa calculated in step 604 is read from the map in (B) of FIG. 15. Then, in step 606, a difference (air/fuel ratio difference) ΔA/F between the air/fuel ratio read in the step 600 and the stoichiometric air/fuel ratio is calculated. Next, in step 607, the decrease quantity correction amount ΔQd according to the air/fuel ratio difference ΔA/F calculated in step 606, namely, the correction amount ΔQd for decreasing the base fuel injection quantity so that the air/fuel ratio of the mixture is made leaner than the stoichiometric air/fuel ratio when it is determined that the air/fuel ratio of the mixture is richer than the stoichiometric air/fuel ratio is read from the map in (A) of FIG. 3. Then, in step 608, the base fuel injection quantity Qbn calculated in step 111 shown in FIG. 8 is decreased by a value (ΔQd×K1×K2) obtained by multiplying the decrease quantity correction amount ΔQd read in step 607 multiplied by the correction coefficient K1 read in step 603 and the correction coefficient K3 read in step 605 (Qbn−ΔQd×K1×K3), this decreased base fuel injection quantity (Qbn−ΔQd×K1×K3) is input to the target fuel injection quantity TQ, and the routine ends. In this case, the operation of the fuel injection valve is controlled so that the fuel corresponding to the target fuel injection quantity TQ set in step 608 is injected, and, as a result, the air/fuel ratio of the mixture becomes leaner than the stoichiometric air/fuel ratio.

In contrast, when it is determined that A/F≧TA/Fst in step 601, namely when it is determined that the air/fuel ratio of the mixture is leaner than the stoichiometric air/fuel ratio, and when the routine therefore proceeds to step 610, the difference between the air/fuel ratio read in the step 600 and the stoichiometric air/fuel ratio (air/fuel ratio difference) ΔA/F is calculated. Then, in step 611, the increase quantity correction amount ΔQi according to the air/fuel ratio difference ΔA/F calculated in step 610, namely, the correction amount ΔQi for increasing the base fuel injection quantity so that the air/fuel ratio of the mixture is made richer than the stoichiometric air/fuel ratio when it is determined that the air/fuel ratio of the mixture is leaner than the stoichiometric air/fuel ratio is read from the map in (B) of FIG. 3. Then, in step 612, the base fuel injection quantity Qbn calculated in step 111 shown in FIG. 8 is increased by the increase quantity correction amount ΔQi read in step 611 (Qbn+ΔQi), this increased base fuel injection quantity (Qbn+ΔQi) is input to the target fuel injection quantity TQ, and the routine ends. In this case, the operation of the fuel injection valve is controlled so that the fuel corresponding to the target fuel injection quantity TQ set in step 612 is injected from the fuel injection valve 39, and, as a result, the air/fuel ratio of the mixture becomes richer than the stoichiometric air/fuel ratio.

By the way, the target air/fuel ratio is set at the stoichiometric air/fuel ratio in the temporary stoichiometric control according to the above-mentioned embodiments. In this case, the air/fuel ratio of the mixture is made leaner or richer than the stoichiometric air/fuel ratio, so that the air/fuel ratio of the entire mixture is controlled to be the stoichiometric air/fuel ratio. Of course, even if the target air/fuel ratio is set to an air/fuel ratio richer than the stoichiometric air/fuel ratio (air/fuel ratio richer than the stoichiometric air/fuel ratio is referred to as a “rich air/fuel ratio” hereinafter) in the temporary stoichiometric control according to the first embodiment, the air/fuel ratio of the mixture is made leaner or richer than the rich air/fuel ratio, so that the air/fuel ratio of the mixture is controlled to be the rich air/fuel ratio as a whole. In this case, if the decrease quantity correction amount read from the map in (A) of FIG. 3 itself is directly used as a decrease quantity correction amount for the base fuel injection quantity, and if the decrease quantity correction amount and a degree of richness of the target air/fuel ratio with respect to the stoichiometric air/fuel ratio (degree of richness with respect to the stoichiometric air/fuel ratio is referred to a “degree of richness” hereinafter) are set so that the air/fuel ratio of the mixture is not excessively leaner than the stoichiometric air/fuel ratio when the base fuel injection quantity is decreased by the decrease quantity correction amount, the fuel which has been accumulated in the three way catalyst after the end of the rich control will not be burned at once, and therefore, the fuel accumulated in the three way catalyst is purified/treated while the heat deterioration of the three way catalyst is restrained. In view of the above, the following temporary stoichiometric control is carried out in place of the temporary stoichiometric control according to the above-mentioned embodiments.

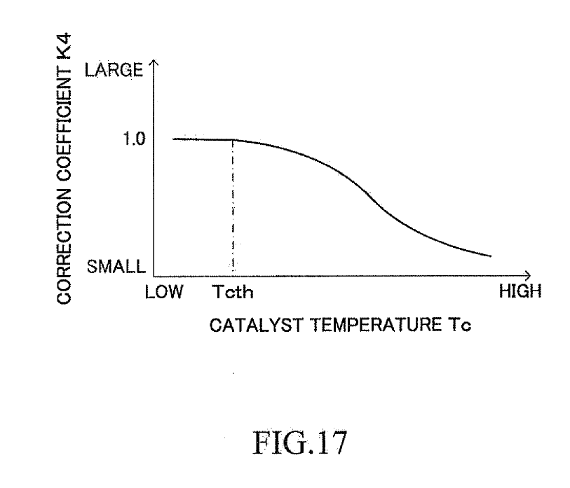

That is, according to this embodiment (referred to as a “fourth embodiment” hereinafter), when the air/fuel ratio of the mixture becomes leaner than the target air/fuel ratio using the decrease quantity correction amount read from the map in FIG. 3(A) for decreasing the base fuel injection quantity when the air/fuel ratio of the mixture is richer than the target air/fuel ratio, a coefficient for correcting the stoichiometric air/fuel ratio serving as the base air/fuel ratio, to an air/fuel ratio slightly richer than the stoichiometric air/fuel ratio which has the quantity of the oxygen in the exhaust gas flowing into the three way catalyst become (below) the catalyst heat deterioration oxygen quantity (quantity of oxygen causing the heat deterioration of the three way catalyst), is obtained for respective catalyst temperatures (temperatures of the three way catalyst 52) by an experiment or the like, and the coefficient is stored in the ECU 70 as a correction coefficient K2 as a function of the catalyst temperature Tc in a form of a map shown in FIG. 17. As appreciated from FIG. 17, the correction coefficient K4 takes a value 1.0 when the catalyst temperature Tc is equal to or lower than the certain temperature Tcth, and the correction coefficient K1 takes a value which is smaller than 1.0 and becomes smaller as the catalyst temperature Tc becomes higher when the catalyst temperature Tc is higher than the certain temperature Tcth. The correction coefficient K4 is read from the map shown in FIG. 17 based on the catalyst temperature Tc during the temporary stoichiometric control.

During the temporary stoichiometric control, the correction coefficient K4 read from the map shown in FIG. 17 is multiplied by the stoichiometric air/fuel ratio serving as the base air/fuel ratio, and this base air/fuel ratio multiplied by the correction coefficient K4 is set as a target air/fuel ratio (target air/fuel ratio slightly richer than the stoichiometric air/fuel ratio is referred to a “target slightly rich air/fuel ratio” hereinafter).

Then, in the temporary stoichiometric control according to the fourth embodiment, the intake air quantity is calculated by multiplying the quantity of the air detected by the airflow meter 61 by the intake air quantity calculation coefficient, and the quantity of the fuel, to be injected from the fuel injection valve 39 and to have the air/fuel ratio of the mixture coincide with the target slightly rich air/fuel ratio, is calculated as the base slightly rich fuel injection quantity based on the calculated intake air quantity.

Further, in the temporary stoichiometric control according to the fourth embodiment, the detected air/fuel ratio (air/fuel ratio detected by the air/fuel ratio sensor 53) and the target slightly rich air/fuel ratio are compared with each other. When the detected air furl ratio is smaller than the target slightly rich air/fuel ratio, namely, when the detected air/fuel ratio is richer than the target slightly rich air/fuel ratio, the base slightly rich fuel injection quantity calculated as described above is decreased by the decrease quantity correction amount ΔQd read from the map in (A) of FIG. 3, and this decreased base slightly rich fuel injection quantity is set to the target fuel injection quantity.

Thereafter, the fuel injection valve is controlled in such a manner that a fuel of the target fuel injection quantity set in this way is injected from the fuel injection valve 39. Accordingly, the air/fuel ratio of the mixture richer than the target slightly rich air/fuel ratio is made leaner than the target slightly rich air/fuel ratio, and is made slightly leaner than the stoichiometric air/fuel ratio. In this way, since the air/fuel ratio of the mixture is made slightly leaner than the stoichiometric air/fuel ratio when the air/fuel ratio of the mixture is made leaner than the target slightly rich air/fuel ratio, the fuel accumulated in the three way catalyst is purified/treated owing to the burning while the heat deterioration of the three way catalyst due to the burning of the fuel accumulated in the three way catalyst 52 is restrained.

On the other hand, in the temporary stoichiometric control according to the fourth embodiment, when the detected air/fuel ratio is larger than the target slightly rich air/fuel ratio, namely when the detected air/fuel ratio is leaner than the target slightly rich air/fuel ratio, the base slightly rich fuel injection quantity calculated as described above is increased by the increase quantity correction amount read from the map in (B) of FIG. 3, and this increased base slightly rich fuel injection quantity is set to the target fuel injection quantity.

Thereafter, the fuel injection valve is controlled in such a manner that a fuel of the target fuel injection quantity set in this way is injected from the fuel injection valve 39. Accordingly, the air/fuel ratio of the mixture leaner than the target slightly rich air/fuel ratio is made richer than the target slightly rich air/fuel ratio.

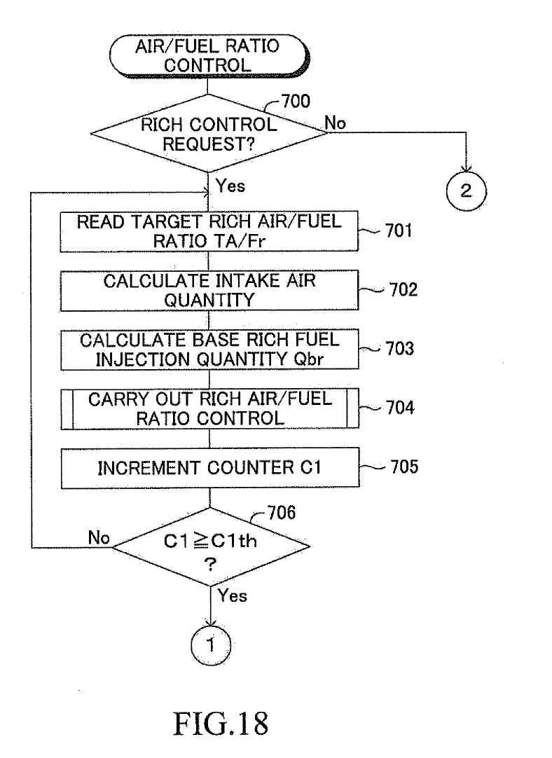

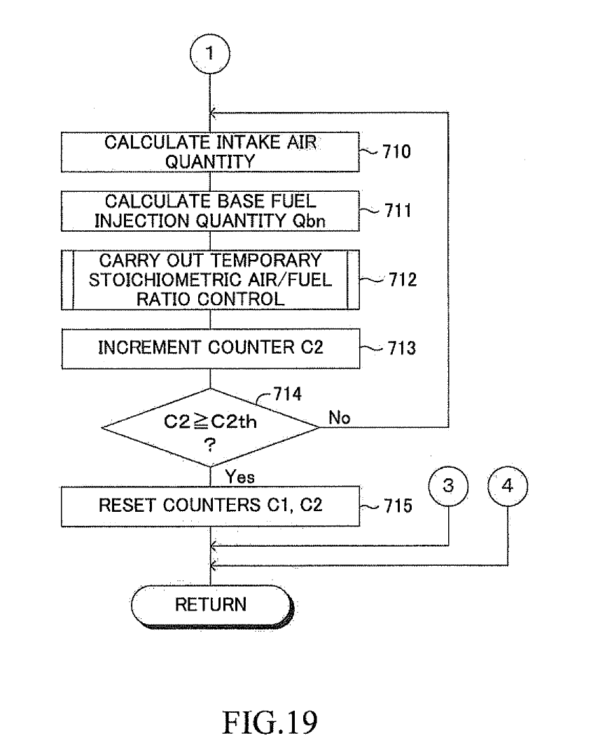

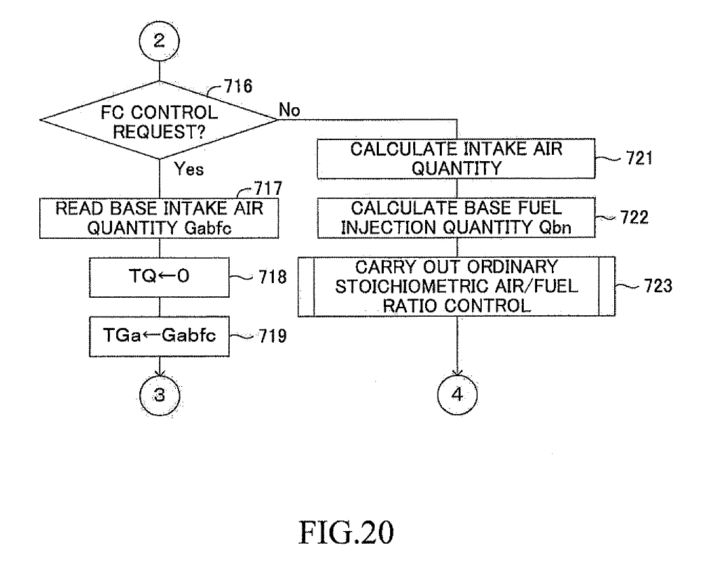

Next, there will be described an example of flowcharts carrying out the air/fuel ratio control according to the fourth embodiment. In the control of the air/fuel ratio according to the fourth embodiment, the flowcharts shown in FIGS. 18-20, 10, 12, and 21 are used. The flowcharts shown in FIGS. 10 and 12 have already been described, and a description thereof is therefore omitted. Further, steps 700-706 in FIG. 18 correspond to steps 100-106 in FIG. 7, steps 713-715 in FIG. 19 correspond to steps 113-115 in FIG. 8, and steps 716-723 in FIG. 20 correspond to the steps 116-123 in FIG. 9, and a description thereof is therefore omitted. Thus, a description will be given of remaining steps in FIG. 18.

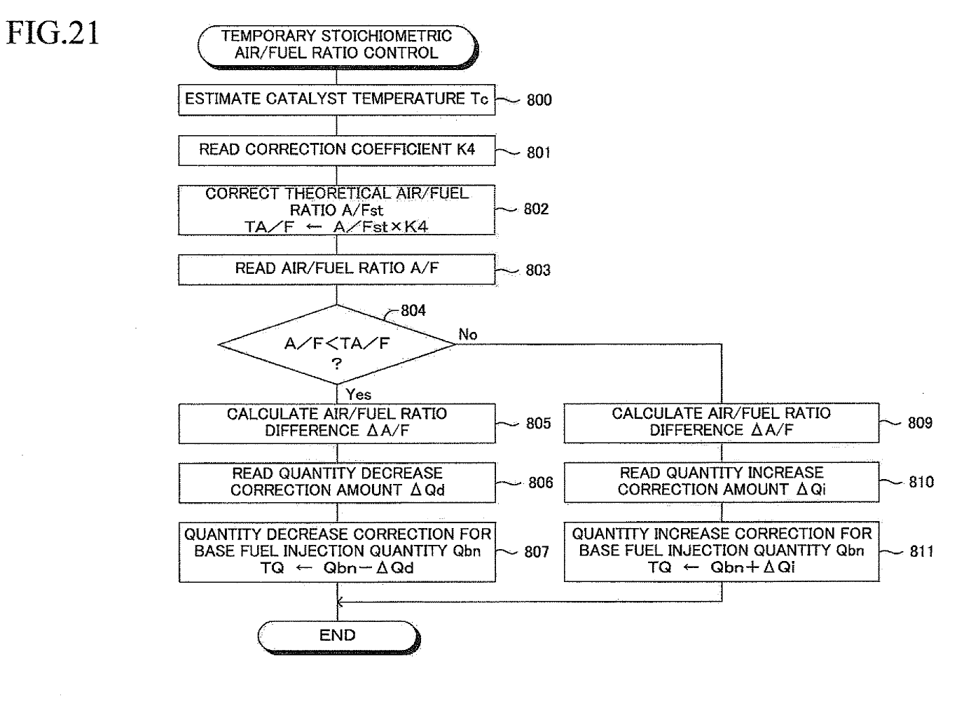

According to the fourth embodiment, when it is determined that the counter C1 representing the elapsed period after the start of the rich control exceeds the predetermined period C1th (C1≧C1th) in step 706 shown in FIG. 18, and thereafter, when the routine proceeds to step 710 shown in FIG. 19, the intake air quantity is calculated by multiplying the quantity of the air detected by the airflow meter 61 by the intake air quantity calculation coefficient. Then, in step 711, the quantity of the fuel, to be injected from the fuel injection valve 39 and to have the air/fuel ratio of the mixture coincide with the target air/fuel ratio, is calculated as the base slightly rich fuel injection quantity Qbsr based on the intake air quantity calculated in the step 710 in a step 711. Subsequently, in step 712, the temporary stoichiometric air/fuel ratio control shown in FIG. 21 is carried out.

When the temporary stoichiometric air/fuel ratio control shown in FIG. 21 starts, the temperature Tc of the three way catalyst (catalyst temperature) is firstly estimated in step 800. Then, in step 801, the correction coefficient K4 according to the catalyst temperature Tc estimated in step 800 is read from the map shown in FIG. 17. Then, in step 802, a value (A/Fst×K4) obtained by multiplying the stoichiometric air/fuel ratio A/Fst by the correction coefficient K4 read in the step 801 is input to a target air/fuel ratio TA/F. Thereafter, in step 803, the air/fuel ratio A/F detected by the air/fuel ratio sensor 53 is read. Then, in step 804, it is determined whether or not the air/fuel ratio A/F read in the step 802 is smaller than the target air/fuel ratio set in step 802, namely the target slightly rich air/fuel ratio (A/F<TA/F), that is, it is determined whether or not the air/fuel ratio of the mixture is richer than the target slightly rich air/fuel ratio. When it is determined that A/F<TA/F, namely, when it is determined that the air/fuel ratio of the mixture is richer than the target slightly rich air/fuel ratio, the routine proceeds to steps starting from step 805, and the air/fuel ratio control for making the air/fuel ratio of the mixture leaner than the target slightly rich air/fuel ratio is carried out. In contrast, when it is determined that A/F≧TA/F, namely, when it is determined that the air/fuel ratio of the mixture is leaner than the target slightly rich air/fuel ratio, the routine proceeds to steps starting from step 809, and the air/fuel ratio control for making the air/fuel ratio of the mixture richer than the target slightly rich air/fuel ratio is carried out.

When it is determined that A/F<TA/F in the step 804, namely when it is determined that the air/fuel ratio of the mixture is richer than the target slightly rich air/fuel ratio, and when the routine therefore proceeds to step 805, a difference (air/fuel ratio difference) ΔA/F of the target slightly rich air/fuel ratio set in the step 802 with respect to the air/fuel ratio read in the step 803 is calculated. Then, in step 806, the decrease quantity correction amount ΔQd according to the air/fuel ratio difference ΔA/F calculated in step 805, namely, the correction amount ΔQd for decreasing the base fuel injection quantity so that the air/fuel ratio of the mixture is made leaner than the target slightly rich air/fuel ratio when it is determined that the air/fuel ratio of the mixture is richer than the target slightly rich air/fuel ratio, is read from the map shown in (A) of FIG. 3. Thereafter, in step 807, the base slightly rich fuel injection quantity Qbsr calculated in step 711 shown in FIG. 19 is decreased by the decrease quantity correction amount ΔQd read in step 806 (Qbsr−ΔQd), this decreased base slightly rich fuel injection quantity (Qbsr−ΔQd) is input to the target fuel injection quantity TQ, and the routine ends. In this case, the operation of the fuel injection valve is controlled so that the fuel corresponding to the target fuel injection quantity TQ set in step 807 is injected, and, as a result, the air/fuel ratio of the mixture becomes leaner than the target slightly rich air/fuel ratio.

In contrast, when it is determined that A/F≧TA/F in step 804, namely when it is determined that the air/fuel ratio of the mixture is leaner than the target slightly rich air/fuel ratio, and when the routine therefore proceeds to step 809, a difference (air/fuel ratio difference) ΔA/F of the target slightly rich air/fuel ratio set in the step 802 with respect to the air/fuel ratio read in step 803 is calculated. Then, in step 810, the increase quantity correction amount ΔQi according to the air/fuel ratio difference ΔA/F calculated in step 809, namely, the correction amount ΔQi for increasing the base fuel injection quantity so that the air/fuel ratio of the mixture becomes richer than the target slightly rich air/fuel ratio when it is determined that the air/fuel ratio of the mixture is leaner than the target slightly rich air/fuel ratio is read from the map shown in (B) of FIG. 3. Subsequently, in step 811, the base slightly rich fuel injection quantity Qbsr calculated in step 711 shown in FIG. 19 is increased by the increase quantity correction amount ΔQi read in step 810 (Qbsr+ΔQi), this increased base slightly rich fuel injection quantity (Qbsr+ΔQi) is input to the target fuel injection quantity TQ, and the routine ends. In this case, the operation of the fuel injection valve is controlled so that the fuel corresponding to the target fuel injection quantity TQ set in step 811 is injected from the fuel injection valve 39, and, as a result, the air/fuel ratio of the mixture becomes richer than the target slightly rich air/fuel ratio.

By the way, in the temporary stoichiometric control according to the first embodiment, the target air/fuel ratio is set to the stoichiometric air/fuel ratio, the base fuel injection quantity is decreased so that the air/fuel ratio of the mixture becomes leaner than the stoichiometric air/fuel ratio when the air/fuel ratio of the mixture is richer than the stoichiometric air/fuel ratio, and the base fuel injection quantity is increased so that the air/fuel ratio of the mixture becomes richer than the stoichiometric air/fuel ratio when the air/fuel ratio of the mixture is leaner than the stoichiometric air/fuel ratio. When the air/fuel ratio of the mixture is controlled in this way, a period in which the air/fuel ratio of the mixture is richer than the stoichiometric air/fuel ratio and a period in which the air/fuel ratio of the mixture is leaner than the stoichiometric air/fuel ratio are basically equal to each other. Thus, a period in which the air/fuel ratio of the exhaust gas flowing into the three way catalyst is richer than the stoichiometric air/fuel ratio (this period is referred to as a “rich period” hereinafter) and a period in which the air/fuel ratio of the exhaust gas flowing into the three way catalyst is leaner than the theoretical sir fuel ratio (this period is referred to as a “lean period” hereinafter) are thus equal to each other. As described above, it is necessary to make the quantity of the oxygen in the exhaust gas flowing into the three way catalyst smaller than the catalyst heat deterioration oxygen quantity (quantity of the oxygen which can restrain the heat deterioration of the three way catalyst) in order to restrain the heat deterioration of the three way catalyst after the end of the rich control. If the air/fuel ratio of the mixture is controlled in such a manner that the rich period is longer than the lean period, the lean period is shortened by an amount by which the rich period is longer, and therefore, the quantity of the oxygen in the exhaust gas flowing into the three way catalyst is deceased as a whole. In addition, if the rich period is set in such a manner that the quantity of the oxygen in the exhaust gas flowing into the three way catalyst is (below) the catalyst heat deterioration oxygen quantity as a whole, the heat deterioration of the three way catalyst after the end of the rich control is restrained. In view of the above, the following temporary stoichiometric control may be carried out in place of the temporary stoichiometric control according to the first embodiment.

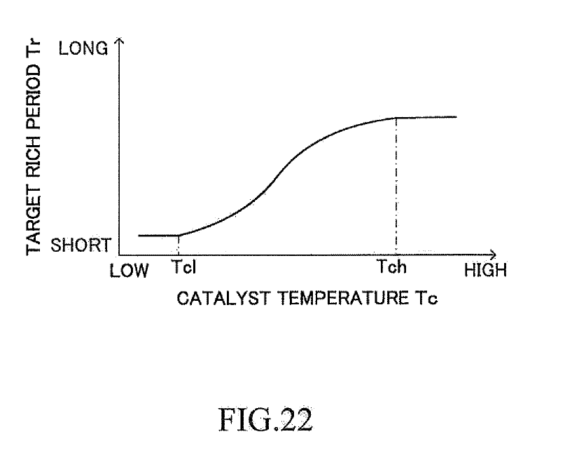

That is, according to this embodiment (referred to as a “fifth embodiment” hereinafter) considering a fact that the catalyst heat deterioration oxygen quantity decreases as the catalyst temperature (temperature of the three way catalyst) is higher, and a fact that the quantity of the oxygen in the exhaust gas flowing into the three way catalyst decreases as the rich period is longer, the rich period which can restrain the quantity of the oxygen in the exhaust gas flowing into the three way catalyst to the catalyst heat deterioration oxygen quantity is obtained by an experiment or the like for respective catalyst temperatures, this rich period is stored in the ECU 70 as a target rich period Tr as a function of the catalyst temperature Tc in a form of a map shown in FIG. 22. As appreciated from FIG. 22, the target rich period Tr becomes longer as the catalyst temperature Tc is higher when the catalyst temperature Tc is between a certain temperature Tel and a certain temperature Tch, the rich period Tr is a certain constant short period independently of the catalyst temperature Tc when the catalyst temperature Tc is lower than the certain temperature Tel, and the rich period Tr is a certain constant long period independently of the catalyst temperature Tc when the catalyst temperature Tc is higher than the certain temperature Tch.

In the temporary stoichiometric control according to the fifth embodiment, when the air/fuel ratio of the mixture is richer than the stoichiometric air/fuel ratio serving as the target air/fuel ratio, the calculated base fuel injection quantity Qbn is decreased by the decrease quantity correction amount read from the map in (A) of FIG. 3 so that the air/fuel ratio of the mixture becomes leaner than the stoichiometric air/fuel ratio, and this decreased base fuel injection quantity is set to the target fuel injection quantity. Thereafter, the fuel injection valve is controlled in such a manner that a fuel of the target fuel injection quantity set in this way is injected from the fuel injection valve 39.

In contrast, in the temporary stoichiometric control according to the fifth embodiment, when the air/fuel ratio of the mixture is leaner than the stoichiometric air/fuel ratio serving as the target air/fuel ratio, the calculated base fuel injection quantity Qbn is increased by the increase quantity correction amount read from the map in (B) of FIG. 3 so that the air/fuel ratio of the mixture becomes richer than the stoichiometric air/fuel ratio, and this increased base fuel injection quantity is set to the target fuel injection quantity. Thereafter, the fuel injection valve is controlled in such a manner that a fuel of the target fuel injection quantity set in this way is injected from the fuel injection valve 39.

In the temporary stoichiometric control according to the fifth embodiment, the target rich period according to the catalyst temperature Tc is read from the map in FIG. 22. Then, even when the air/fuel ratio of the mixture is richer than the stoichiometric air/fuel ratio, a control is continued until the target rich period read from the map in FIG. 22 elapses in which the base fuel injection quantity increased by the increase quantity correction amount is set to the target fuel injection quantity. Accordingly, the lean period becomes shorter by an amount by which the rich period becomes longer, and therefore, the heat deterioration of the three way catalyst after the end of the rich control is restrained.

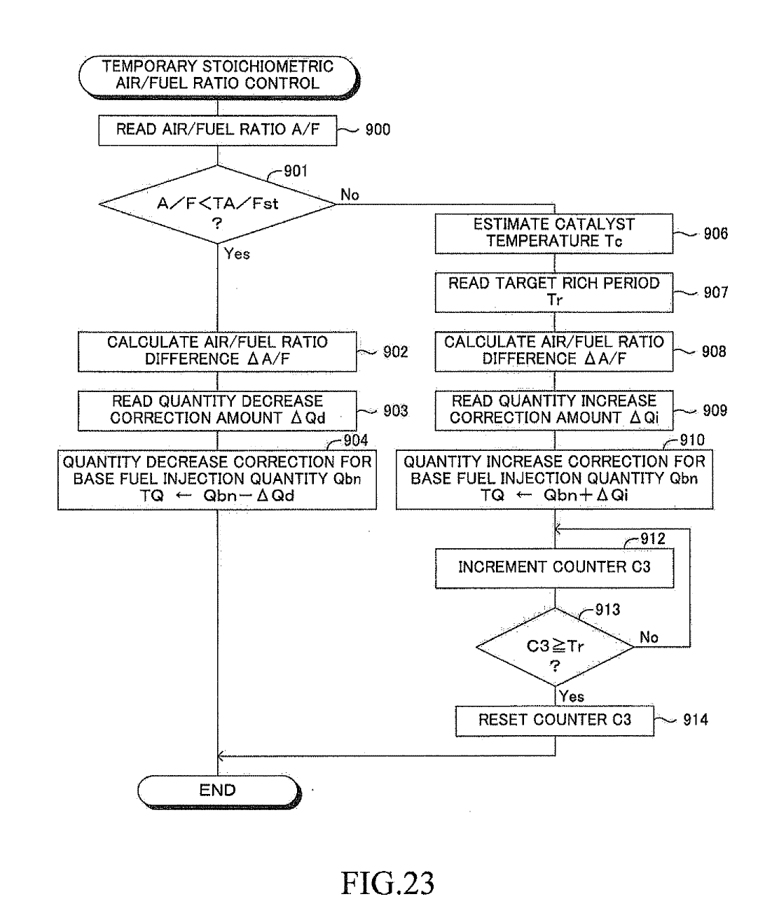

Next, there will be described an example of flowcharts carrying out the air/fuel ratio control according to the fifth embodiment. In the control of the air/fuel ratio according to the fifth embodiment, the flowcharts shown in FIGS. 7-9, 10, 12, and 23 are used. The flowcharts shown in FIGS. 7-9, 10, and 12 have already been described, and a description thereof is therefore omitted. Thus, a description will now be given of the flowchart shown in FIG. 23.

According to the fifth embodiment, when it is determined that the counter C1 representing the elapsed period after the start of the rich control exceeds the predetermined period C1th (C1≧C1th) in step 106 shown in FIG. 7, the intake air quantity and the base fuel injection quantity Qbn are calculated in steps 110 and 111 shown in FIG. 8, and when the routine proceeds to the step 112, the temporary stoichiometric air/fuel ratio control shown in FIG. 23 is carried out.

When the temporary stoichiometric air/fuel ratio control shown in FIG. 23 starts, the air/fuel ratio A/F detected by the air/fuel ratio sensor 53 is firstly read in step 900. Then, in step 901, it is determined whether or not the air/fuel ratio A/F read in step 900 is smaller than the stoichiometric air/fuel ratio TA/Fst (A/F<TA/Fst), namely, it is determined whether or not the air/fuel ratio of the mixture is richer than the stoichiometric air/fuel ratio. When it is determined that A/F<TA/Fst, namely, when it is determined that the air/fuel ratio of the mixture is richer than the stoichiometric air/fuel ratio, the routine proceeds to steps starting from step 902, and the air/fuel ratio control for making the air/fuel ratio of the mixture leaner than the stoichiometric air/fuel ratio is carried out. On the other hand, when it is determined that A/F≧TA/Fst, namely, when it is determined that the air/fuel ratio of the mixture is leaner than the stoichiometric air/fuel ratio, the routine proceeds to steps starting from step 906, and the air/fuel ratio control for making the air/fuel ratio of the mixture richer than the stoichiometric air/fuel ratio is carried out.

When it is determined that A/F<TA/Fst in step 901, namely when it is determined that the air/fuel ratio of the mixture is richer than the stoichiometric air/fuel ratio, and the routine proceeds to the step 902, a difference (air/fuel ratio difference) ΔA/F between the air/fuel ratio read in step 900 and the stoichiometric air/fuel ratio is calculated. Then, in step 903, the decrease quantity correction amount ΔQd according to the air/fuel ratio difference ΔA/F calculated in step 902, namely, the correction amount ΔQd for decreasing the base fuel injection quantity so that the air/fuel ratio of the mixture is made leaner than the stoichiometric air/fuel ratio when it is determined that the air/fuel ratio of the mixture is richer than the stoichiometric air/fuel ratio is read from the map in (A) of FIG. 3. Then, in step 904, the base fuel injection quantity Qbn calculated in step 111 shown in FIG. 8 is decreased by the decrease quantity correction amount ΔQd read in step 903 (Qbn−ΔQd), this decreased base fuel injection quantity (Qbn−ΔQd) is input to the target fuel injection quantity TQ, and the routine ends. In this case, the operation of the fuel injection valve is controlled so that the fuel corresponding to the target fuel injection quantity TQ set in step 904 is injected, and, as a result, the air/fuel ratio of the mixture becomes leaner than the stoichiometric air/fuel ratio.

In contrast, when it is determined that A/F≧TA/Fst in step 901, namely, when the air/fuel ratio of the mixture is leaner than the stoichiometric air/fuel ratio, and when the routine therefore proceeds to step 906, the temperature of the three way catalyst (catalyst temperature) Tc is estimated. Then, in step 907, the target rich period Tr according to the catalyst temperature Tc estimated in step 906 is read from the map in FIG. 22. Next, in step 908, a difference (air/fuel ratio difference) ΔA/F between the air/fuel ratio read in step 900 and the stoichiometric air/fuel ratio is calculated. Then, in step 909, the increase quantity correction amount ΔQi according to the air/fuel ratio difference ΔA/F calculated in step 908, namely, the correction amount ΔQi for increasing the base fuel injection quantity so that the air/fuel ratio of the mixture is made richer than the stoichiometric air/fuel ratio when it is determined that the air/fuel ratio of the mixture is leaner than the stoichiometric air/fuel ratio is read from the map in (B) of FIG. 3. Then, in step 910, the base fuel injection quantity Qbn calculated in step 111 shown in FIG. 8 is increased by the increase quantity correction amount ΔQi read in step 909 (Qbn+ΔQi), this increased base fuel injection quantity (Qbn+ΔQi) is input to the target fuel injection quantity TQ, and the routine ends. Subsequently, a counter C3 is incremented, the counter C3 representing a elapsed period after a point in time at which the base fuel injection quantity Qbn increased by the increase quantity correction amount ΔQi in such a manner that the air/fuel ratio of the mixture is made richer than the stoichiometric air/fuel ratio is input to the target fuel injection quantity TQ. Thereafter, in step 913, it is determined whether or not the counter C3 incremented in step 912 exceeds the target rich period Tr read in step 907 (C3≧Tr). When it is determined that C3<Tr, the routine returns to step 912, and step 912 is executed. In other words, the step 912 is repeated until it is determined that C3≧Tr in step 913. Then, when it is determined that C3≧Tr in step 913, the routine proceeds to step 914, the counter C3 is reset, and the routine ends. In this case, the operation of the fuel injection valve is controlled so that the fuel corresponding to the target fuel injection quantity TQ set in step 910 is injected from the fuel injection valve 39 until the target rich period elapses, and, as a result, the air/fuel ratio of the mixture becomes richer than the stoichiometric air/fuel ratio.

By the way, in the above-mentioned embodiments, the temporary stoichiometric control is always carried out after the end of the rich control. However, the ordinary stoichiometric control may be carried out without executing the temporary stoichiometric control, if the catalyst temperature (temperature of the three way catalyst) is lower than a temperature at which the heat deterioration of the three way catalyst 52 does not occur even when the ordinary stoichiometric control is carried out after the end of the rich control. Further, even if the fuel cut control is carried out after the end of the rich control, and if the catalyst temperature is lower than a temperature at which the heat deterioration of the three way catalyst does not occur, the fuel cut control may be carried out without executing the temporary stoichiometric control. Thus, the temporary stoichiometric control may be carried out as described below in the above-mentioned embodiments.

That is, according to this embodiment (referred to as a “sixth embodiment” hereinafter), the catalyst temperature (temperature of the three way catalyst) is estimated when the rich control is finished. Then, in a case where an engine state is a state in which the ordinary stoichiometric control is supposed to carried out, when the catalyst temperature is lower than a temperature which causes the heat deterioration of the three way catalyst if the ordinary stoichiometric control is carried out (this temperature is referred to as a “first catalyst heat deterioration temperature” hereinafter), the ordinary stoichiometric control is carried out without carrying out the temporary stoichiometric control. In contrast, when the catalyst temperature is equal to or higher than the first catalyst heat deterioration temperature, the temporary stoichiometric control is carried out. Further, in a case where an engine state is a state in which the fuel cut control is supposed to carried out, when the catalyst temperature is lower than a temperature which causes the heat deterioration of the three way catalyst if the fuel cut control is carried out (this temperature is referred to as a “second catalyst heat deterioration temperature” hereinafter), the fuel cut control is carried out without carrying out the temporary stoichiometric control. In contrast, when the catalyst temperature is equal to or higher than the second catalyst heat deterioration temperature, the temporary stoichiometric control is carried out.

According to this configuration, when the catalyst temperature is lower than the first catalyst heat deterioration temperature, the temporary stoichiometric control is not carried out, and the ordinary stoichiometric control is carried out. Thus, the purification function of the three way catalyst is maximally provided earlier accordingly. Moreover, the catalyst temperature is lower than the second catalyst heat deterioration temperature, the temporary stoichiometric control is not carried out, and the fuel cut control is carried out. Thus, the fuel consumption is improved.

It should be noted that the quantity of the oxygen in the exhaust gas flowing into the three way catalyst when the fuel cut control is carried out is larger than the quantity of the oxygen in the exhaust gas flowing into the three way catalyst when the ordinary stoichiometric control is carried out, and therefore, the second catalyst heat deterioration temperature is set lower than the first catalyst heat deterioration temperature.

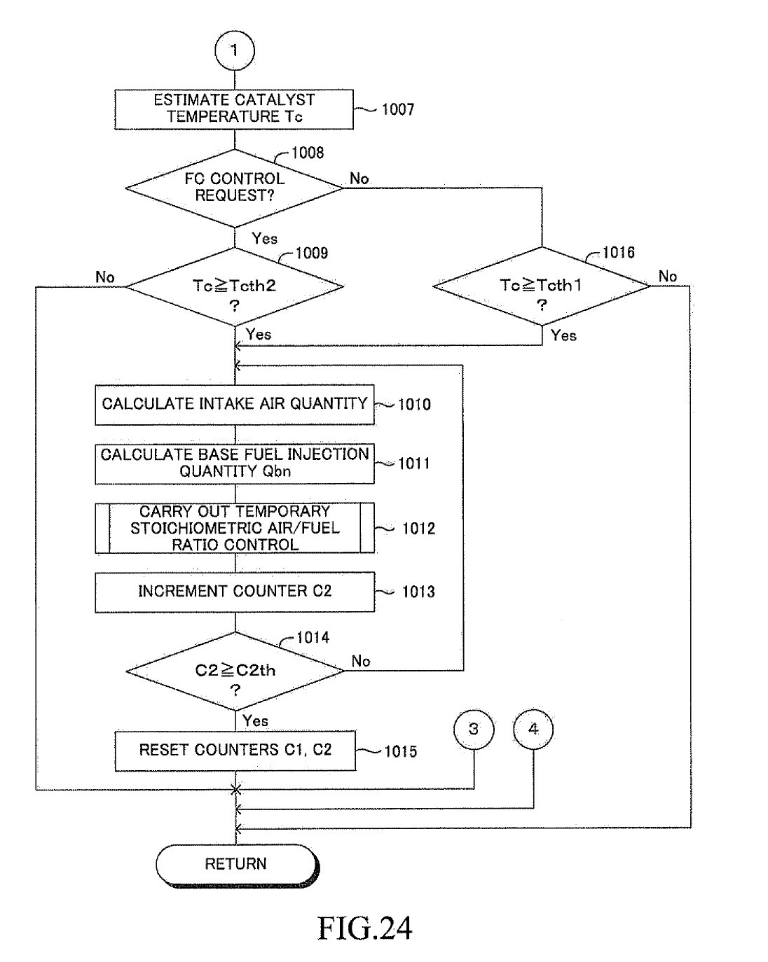

Next, there will be described an example of flowcharts carrying out the air/fuel ratio control according to the sixth embodiment. In the control of the air/fuel ratio according to the sixth embodiment, the flowcharts shown in FIGS. 7, 9, 10-12, and 24 are used. The flowcharts shown in FIGS. 7, 9, and 10-12 have already been described, and a description thereof is therefore omitted. Thus, a description will now be given of the flowchart in FIG. 24.

According to the sixth embodiment, when it is determined that the counter C1 representing the elapsed period after the start of the rich control exceeds the predetermined period C1th (C1≧C1th) in step 106 shown in FIG. 7, and thereafter, when the routine proceeds to step 1007, the catalyst temperature (temperature of three way catalyst) Tc is estimated. Then, in step 1008, it is determined whether or not the execution of the fuel cut control (FC control) is required. When it is determined that the execution of the fuel cut control is required, the routine proceeds to steps starting from step 1009. In contrast, when it is determined that the execution of the fuel cut control is not required, the routine proceeds to steps starting from step 1016.

When it is determined that the execution of the fuel cut control is required in step 1008, and when the routine therefore proceeds to a step 1009, it is determined whether or not the catalyst temperature Tc estimated in step 1007 is equal to or higher than the second catalyst heat deterioration temperature (temperature causing the heat deterioration of the three way catalyst if the fuel cut control is carried out) (Tc≧Tcth2). When it is determined that Tc≧Tcth, the routine proceeds to steps starting from step 1010, and the temporary stoichiometric control is carried out. It should be noted that steps 1010-1015 respectively correspond to steps 110 to 115 in FIG. 8, and a description thereof is therefore omitted. On the other hand, when it is determined that Tc<Tchth2, the routine directly ends. In this case, the routine shown in FIG. 7 then starts, it is determined that the execution of the rich control is not required in step 100, the routine proceeds to the step 116 shown in FIG. 9 in which it is determined that the execution of the fuel cut control is required, the routine thereafter proceeds to the steps starting from step 117, and thus, the fuel cut control is carried out.

In contrast, when it is determined that the execution of the fuel cut control is not required in step 1008, and when the routine therefore proceeds to step 1016, it is determined whether or not the catalyst temperature Tc estimated in step 1007 is equal to or higher than the first catalyst heat deterioration temperature (temperature causing the heat deterioration of the three way catalyst if the ordinary stoichiometric control is carried out) (Tc≧Tcth1). When it is determined that Tc≧Tcth, the routine proceeds to steps starting from step 1010, and the temporary stoichiometric control is carried out. It should be noted that steps 1010-1015 respectively correspond to steps 110 to 115 shown in FIG. 8, and a description thereof is therefore omitted. In contrast, when it is determined that Tc<Tchth1, the routine directly ends. In this case, the routine in FIG. 7 then starts, it is determined that the execution of the rich control is not required in step 100, the routine proceeds to step 116 shown in FIG. 9 in which it is determined that the execution of the fuel cut control is not required, the routine proceeds to the steps starting from step 121, and the ordinary stoichiometric control is carried out.

It should be noted that the restraints of the heat deterioration of the three way catalyst by the temporary stoichiometric control according to each of the embodiments may be properly combined as long as there is no inconsistency.

Moreover, the decrease quantity correction amount is set to a value which decreases as the catalyst temperature is higher in the temporary stoichiometric control according to the respective embodiments. However, the degree of decreasing the decrease quantity correction amount may be set stepwise according to the catalyst temperature. In other words, a range of the catalyst temperature may be divided into a plurality of ranges, a coefficient having a constant value may be provided as a coefficient for decreasing the decrease quantity correction amount in each of the ranges, and the coefficient provided in any of the ranges may be used according to the catalyst temperature, as the coefficient decreasing the decrease quantity correction amount.

Moreover, according to the above-mentioned embodiments, the air/fuel ratio control apparatus of the present invention is applied to the internal combustion engine including the three way catalyst. However, the air fuel control apparatus according to the present invention may be applied to an internal combustion engine including a catalyst having at least oxidization capability.

Moreover, according to the above-mentioned embodiments, the temporary stoichiometric control is carried out, in which the decrease quantity correction amount is made smaller than the decrease quantity correction amount in the ordinary stoichiometric control, in order to restrain the heat deterioration of the three way catalyst according to the catalyst temperature, if the ordinary stoichiometric control or the fuel cut control is carried out after the end of the rich control. However, the present invention can be applied to a case in which lean control is carried out after the end of the rich control, the lean control being a control for controlling the air/fuel ratio of the mixture to be an air/fuel ratio leaner by a predetermined degree than the stoichiometric air/fuel ratio, or for temporarily controlling the air/fuel ratio of the mixture to be an air/fuel ratio leaner by a predetermined degree than the stoichiometric air/fuel ratio In this case, temporary lean control corresponding to temporary stoichiometric control described above is carried out in place of the lean control.

1. An air/fuel ratio control apparatus for an internal combustion engine including a catalyst having an oxidization capability in an exhaust passage, and on which, after rich control for controlling an air/fuel ratio of a mixture formed in a combustion chamber to be an air/fuel ratio richer than stoichiometric air/fuel ratio, lean control for controlling said air/fuel ratio of said mixture formed in said combustion chamber to be an air/fuel ratio leaner by a predetermined degree than said stoichiometric air/fuel ratio, or controlling said air/fuel ratio of said mixture formed in said combustion chamber to temporarily be an air/fuel ratio leaner by said predetermined degree than said stoichiometric air/fuel ratio is carried out, wherein unburned fuel accumulates in said catalyst during said rich control, and said rich control is carried out over a period in which a quantity of said unburned fuel accumulated in said catalyst at point in time at which said rich control ends reaches a quantity causing a heat deterioration of said catalyst due to burning of said unburned fuel accumulated in said catalyst if said lean control is carried out after said rich control, wherein,
a temporary lean control is carried out when said lean control is carried out after said rich control is finished, said temporary lean control being for controlling said air/fuel ratio of said mixture formed in said combustion chamber in such a manner that a degree of how much said air/fuel ratio of said mixture formed in said combustion chamber is leaner than said stoichiometric air/fuel ratio when said air/fuel ratio of said mixture is controlled to be leaner than said stoichiometric air/fuel ratio in said lean control is lower than said predetermined degree in accordance with said temperature of said catalyst.

2. An air/fuel ratio control apparatus for an internal combustion engine including a catalyst having an oxidization capability in an exhaust passage, said apparatus carrying out, after a rich control for controlling an air/fuel ratio of a mixture formed in a combustion chamber to be an air/fuel ratio richer than stoichiometric air/fuel ratio, a lean control for controlling said air/fuel ratio of said mixture formed in said combustion chamber to be an air/fuel ratio leaner by a predetermined degree than said stoichiometric air/fuel ratio, or controlling said air/fuel ratio of said mixture formed in said combustion chamber to temporarily be an air/fuel ratio leaner by said predetermined degree than said stoichiometric air/fuel ratio, wherein unburned fuel accumulates in said catalyst during said rich control, and said rich control is carried out over a period in which a quantity of said unburned fuel accumulated in said catalyst at point in time at which said rich control ends reaches a quantity causing a heat deterioration of said catalyst due to burning of said unburned fuel accumulated in said catalyst if said lean control is carried out after said rich control, wherein,
a temporary lean control is carried out, when said lean control is carried out after said rich control is finished and if a temperature of said catalyst is higher than a predetermined temperature, said temporary lean control being for controlling said air/fuel ratio of said mixture formed in said combustion chamber in such a manner that a degree of how much said air/fuel ratio of said mixture formed in said combustion chamber is leaner than said stoichiometric air/fuel ratio when said air/fuel ratio of said mixture is controlled to be leaner than said stoichiometric air/fuel ratio in said lean control is lower than said predetermined degree in accordance with said temperature of said catalyst.

3. The air/fuel ratio control apparatus for an internal combustion engine according to claim 1, wherein said air/fuel ratio of said mixture formed in said combustion chamber when said air/fuel ratio of said mixture is controlled to be leaner than said stoichiometric air/fuel ratio in said temporary lean control is controlled in such a manner that a degree of how much said air/fuel ratio of said mixture is leaner than said stoichiometric air/fuel ratio becomes smaller with respect to said predetermined degree as said temperature of said catalyst becomes higher.

4. The air/fuel ratio control apparatus for an internal combustion engine according to claim 1, wherein said air/fuel ratio of said mixture formed in said combustion chamber when said air/fuel ratio of said mixture is controlled to be leaner than said stoichiometric air/fuel ratio in said temporary lean control is controlled in such a manner that a degree of how much said air/fuel ratio of said mixture is leaner than said stoichiometric air/fuel ratio becomes further smaller with respect to said predetermined degree when a quantity of an air taken into said combustion chamber is smaller than a predetermined quantity.

5. The air/fuel ratio control apparatus for an internal combustion engine according to claim 4, wherein said air/fuel ratio of said mixture formed in said combustion chamber when said air/fuel ratio of said mixture is controlled to be leaner than said stoichiometric air/fuel ratio in said temporary lean control is controlled in such a manner that a degree of how much said air/fuel ratio of said mixture is leaner than said stoichiometric air/fuel ratio becomes further smaller with respect to said predetermined degree as said quantity of said air taken into said combustion chamber is smaller with respect to said predetermined quantity when said quantity of said air taken into said combustion chamber is smaller than said predetermined quantity.

6. The air/fuel ratio control apparatus for an internal combustion engine according to claim 1, wherein said air/fuel ratio of said mixture formed in said combustion chamber when said air/fuel ratio of said mixture is controlled to be leaner than said stoichiometric air/fuel ratio in said temporary lean control is controlled in such a manner that a degree of how much said air/fuel ratio of said mixture is leaner than said stoichiometric air/fuel ratio becomes further smaller than said predetermined degree when an accumulated value of a quantity of an air taken into said combustion chamber after an end of said rich control is smaller than a predetermined value.

7. The air/fuel ratio control apparatus for internal combustion engine according to claim 6, wherein said air/fuel ratio of said mixture formed in said combustion chamber when said air/fuel ratio of said mixture is controlled to be leaner than said stoichiometric air/fuel ratio in said temporary lean control is controlled in such a manner that, when said accumulated value of said quantity of said air taken into said combustion chamber after said end of said rich control is smaller than said predetermined value, a degree of how much said air/fuel ratio of said mixture is leaner than said stoichiometric air/fuel ratio becomes further smaller with respect to said predetermined degree as said accumulated value is smaller with respect to said predetermined value.
